(19) United States
(12) Patent Application Publication
(10) Pub. No.: US 2013/0114562 A1
(43) Pub. Date: May 9, 2013

(54) METHOD AND APPARATUS FOR CONTROLLING UPLINK TRANSMISSION POWER IN WIRELESS COMMUNICATION SYSTEM

(71) Applicants: Hanbyul Seo, Anyang-si (KR); Youngseob Choi, Anyang-si (KR); Kijun Kim, Anyang-si (KR)

(72) Inventors: Hanbyul Seo, Anyang-si (KR); Youngseob Choi, Anyang-si (KR); Kijun Kim, Anyang-si (KR)

(73) Assignee: LG ELECTRONICS INC., Seoul (KR)

(21) Appl. No.: 13/810,438

(22) PCT Filed: Jul. 14, 2011
(86) PCT No.: PCT/KR2011/005188

§ 371 Date: Jan. 15, 2013

Related U.S. Application Data
(60) Provisional application No. 61/364,813, filed on Jul. 16, 2010.
(60) Provisional application No. 61/366,171, filed on Jul. 21, 2010.
(60) Provisional application No. 61/453,945, filed on Mar. 17, 2011.

(51) Int. Cl. H04W 52/14

(52) U.S. Cl. CPC H04W 52/146
USPC 370/329

(57) ABSTRACT

The present invention relates to a method for transmitting uplink transmission power control information by a base station in a wireless communication system, the method comprising: transmitting first transmission power control information, which is applied to a first uplink resource set, to a user equipment; transmitting second transmission power control information, which is applied to a second uplink resource set, to the user equipment; receiving an uplink signal, which is transmitted through one or more uplink resources of the first uplink resource set using uplink transmission power which is based on the first transmission power control information, from the user equipment; and receiving an uplink signal, which is transmitted through one or more uplink resources of the second uplink resource set using uplink transmission power which is based on the second transmission power control information, from the user equipment.

### TECHNICAL FIELD

The present invention relates to a wireless communication system, and more particularly, to a method and apparatus for controlling uplink transmission power in a wireless communication system.

### BACKGROUND ART

FIG. 1 illustrates a heterogeneous network wireless communications system 100 including a macro eNB and a micro eNB. In the description of the present invention, the term “heterogeneous network” refers to a network in which a macro eNB 110 and a micro eNB 120 are present together even though the same Radio Access Technology (RAT) is used.

The macro eNB 110 is a general eNode B (base station) of a wireless communication system which has a broad coverage and high transmission power. The macro eNB 110 may also be referred to as a macro cell.

The micro eNB 120 may also be referred to as a micro cell, a pico cell, a femto cell, a home eNB (HeNB), or a relay. As a small-sized version of the macro eNB 110, the micro eNB 120 may independently perform most of the functions of the macro eNB. The micro eNB 120 may be installed (in an overlay manner) in an area covered by the macro eNB or may be installed (in a non-overlay manner) in a shadow area that cannot be covered by the macro eNB. The micro eNB 120 has a narrower coverage and lower transmission power and may accommodate a smaller number of user equipments (UEs), compared to the macro eNB 110.

UEs 130 and 140 may be directly served by the macro eNB 110 and may also be served by the micro eNB 120. Here, the UE 130, which is directly served by the macro eNB 110, may be referred to as a macro UE and the UE 140, which is directly served by the micro eNB 120, may be referred to as a micro UE. In some cases, the UE 140 which is present within the coverage of the micro eNB 120 may be served by the macro eNB 110.

The micro eNB may be classified into two types according to access limitations of the UE. The first type is a Closed Subscriber Group (CSG) micro eNB, and the second type is an Open Access (OA) or Open Subscriber Group (OSG) micro eNB. More specifically, the CSG micro eNB may serve only specific authorized UEs, and the OSG micro eNB may serve all types of UEs without any particular access limitations.

### DISCLOSURE

### Technical Problem

In the heterogeneous network described above, an uplink signal from a UE that is served by a macro eNB may cause strong interference to a micro eNB which is adjacent to (or neighbors) the UE. In addition, when a UE receives a downlink signal from a macro eNB, the downlink signal may cause strong interference to a micro eNB adjacent to the UE.

Inter-cell interference may occur for various reasons in the heterogeneous network. Here, when a cell receives interference from a neighbor cell, the extent of interference from the neighbor cell may not be uniform in all resources (or all resource units). If uplink transmission power of a UE in a cell is equally applied to all resources when the extent of interference that the cell receives from a neighbor cell varies between resources, the UE may fail to perform proper uplink transmission.

An object of the present invention is to provide a method and apparatus for controlling uplink transmission power for each uplink resource (or each uplink resource unit) such that uplink transmission can be efficiently and successfully performed when intercell interference is present.

Objects of the present invention are not limited to those described above and other objects will be clearly understood by those skilled in the art from the following description.

### Technical Solution

A method for transmitting uplink transmission power control information by a base station in a wireless communication system according to an embodiment of the present invention to achieve the above objects may include transmitting first transmission power control information, which is applied to a first uplink resource set, to a user equipment, transmitting second transmission power control information, which is applied to a second uplink resource set, to the user equipment, receiving an uplink signal, which is transmitted through one or more uplink resources of the first uplink resource set using uplink transmission power which is based on the first transmission power control information, from the user equipment, and receiving an uplink signal, which is transmitted through one or more uplink resources of the second uplink resource set using uplink transmission power which is based on the second transmission power control information, from the user equipment.

A method for performing uplink transmission by a user equipment in a wireless communication system according to another embodiment of the present invention to achieve the above objects may include receiving first transmission power control information, which is applied to a first uplink resource set, from a base station, receiving second transmission power control information, which is applied to a second uplink resource set, from the base station, transmitting an uplink signal through one or more uplink resources of the first uplink resource set using uplink transmission power which is based on the first transmission power control information to the base station, and transmitting an uplink signal through one or more uplink resources of the second uplink resource set using uplink transmission power which is based on the second transmission power control information to the base station.

A base station for transmitting uplink transmission power control information in a wireless communication system according to another embodiment of the present invention to achieve the above objects may include a reception module for receiving an uplink signal from a user equipment, a transmission module for transmitting a downlink signal to the user equipment, and a processor for controlling the base station including the reception module and the transmission module. Here, the processor may be configured to transmit first transmission power control information, which is applied to a first uplink resource set, to the user equipment through the transmission module, to transmit second transmission power control information, which is applied to a second uplink resource set, to the user equipment through the transmission module, to receive an uplink signal, which is transmitted through one or more uplink resources of the first uplink resource set using uplink transmission power which is based on the first transmission power control information, from the user equipment through the reception module, and to receive an uplink signal, which is transmitted through one or more uplink resources of the second uplink resource set using uplink transmission power which is based on the second transmission power control information, from the user equipment through the reception module.

A user equipment for performing uplink transmission in a wireless communication system according to another embodiment of the present invention to achieve the above objects may include a reception module for receiving a downlink signal from a base station, a transmission module for transmitting an uplink signal to the base station, and a processor for controlling the user equipment including the reception module and the transmission module. Here, the processor may be configured to receive first transmission power control information, which is applied to a first uplink resource set, from the base station through the reception module, to receive second transmission power control information, which is applied to a second uplink resource set, from the base station through the reception module, to transmit an uplink signal through one or more uplink resources of the first uplink resource set using uplink transmission power which is based on the first transmission power control information to the base station through the transmission module, and to transmit an uplink signal through one or more uplink resources of the second uplink resource set using uplink transmission power which is based on the second transmission power control information to the base station through the transmission module.

The following features may be commonly applied to the above embodiments of the present invention.

The first and second uplink resource sets which are applied respectively to the first and second transmission power control information may be indicated explicitly by the base station. Alternatively, the first and second uplink resource sets may be determined based on a correspondence relationship between one downlink resource of the first downlink resource set in which the first transmission power control information is transmitted and one uplink resource of the first uplink resource set and a correspondence relationship between one downlink resource of the second downlink resource set in which the second transmission power control information is transmitted and one uplink resource of the second uplink resource set.

Here, the correspondence relationship may be a relationship in which uplink grant information transmitted in a downlink resource belonging to the first and second resource sets respectively schedules uplink data transmission in an uplink resource belonging to the first and second uplink resource sets. Alternatively, the correspondence relationship may be a relationship in which acknowledgement information of downlink data transmitted in a downlink resource belonging to the first and second resource sets is transmitted respectively in an uplink resource belonging to the first and second uplink resource sets.

Priority levels for application of transmission power control information for the first and second uplink resource sets may be set and transmission power control information for an uplink resource set with a higher priority level may also be applied to the other uplink resource set.

The first and second transmission power control information may include transmission power control information regarding a Physical Uplink Shared Channel (PUSCH), a Physical Uplink Control Channel (PUCCH), or a Sounding Reference Signal (SRS).

A level of interference from a neighbor cell in the first uplink resource set may be different from a level of interference from the neighbor cell in the second uplink resource set.

It is to be understood that both the foregoing general description and the following detailed description of the present invention are exemplary and explanatory and are intended to provide further explanation of the invention as claimed.

### Advantageous Effects

According to the present invention, it is possible to provide a method and apparatus for controlling uplink transmission power for each uplink resource (or each uplink resource unit) such that it is possible to efficiently and successfully perform uplink transmission when intercell interference is present.

Advantages of the present invention are not limited to those described above and other advantages will be clearly understood by those skilled in the art from the following description.

### DESCRIPTION OF DRAWINGS

The drawings, which are attached to this specification to provide a further understanding of the invention, illustrate various embodiments of the invention and together with the description serve to explain the principle of the invention. In the drawings:

FIG. 1 illustrates a wireless communications system including a macro eNB and a micro eNB;

FIG. 2 illustrates the structure of a radio frame used in a 3 GPP LTE system;

FIG. 3 illustrates a resource grid in a downlink slot;

FIG. 4 illustrates the structure of a downlink subframe;

FIG. 5 illustrates the structure of an uplink subframe;

FIG. 6 illustrates the configuration of a wireless communication system having multiple antennas;

FIG. 7 illustrates a basic concept of uplink power control;

FIG. 8 illustrates exemplary interference coordination in the time domain;

FIG. 9 illustrates exemplary interference coordination in the frequency domain;

FIGS. 10 and 11 illustrate examples in which the amount of interference differs for each resource position;

FIG. 12 illustrates an example of resource-specific power control;

FIG. 13 is a flowchart illustrating an uplink power control method according to an example of the present invention; and

FIG. 14 illustrates configurations of an eNB and a UE according to the present invention.

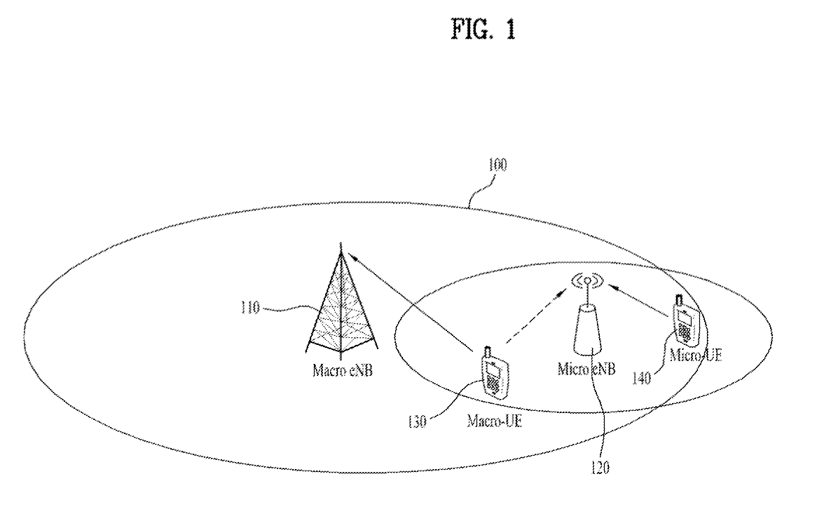

### BEST MODE

The embodiments described below are provided by combining components and features of the present invention in specific forms. The components or features of the present invention can be considered optional unless explicitly stated otherwise. The components or features may be implemented without being combined with other components or features. The embodiments of the present invention may also be provided by combining some of the components and/or features. The order of the operations described below in the embodiments of the present invention may be changed. Some components or features of one embodiment may be included in another embodiment or may be replaced with corresponding components or features of another embodiment.

The embodiments of the present invention have been described focusing mainly on the data communication relationship between a terminal and a Base Station (BS). The BS is a terminal node in a network which performs communication directly with the terminal. Specific operations which have been described as being performed by the BS may also be performed by an upper node as needed.

That is, it will be apparent to those skilled in the art that the BS or any other network node may perform various operations for communication with terminals in a network including a number of network nodes including BSs. Here, the term “base station (BS)” may be replaced with another term such as “fixed station”, “Node B”, “eNode B (eNB)”, or “access point”. The BS (eNB) described in this disclosure conceptually includes a cell or sector. The term “relay” may be replaced with another term such as “Relay Node (RN)” or “Relay Station (RS)”. The term “terminal” may be replaced with another term such as “User Equipment (UE)”, “Mobile Station (MS)”, “Mobile Subscriber Station (MSS)”, or “Subscriber Station (SS)”.

Specific terms used in the following description are provided for better understanding of the present invention and can be replaced with other terms without departing from the spirit of the present invention.

In some instances, known structures and devices are omitted or shown in block diagram form, focusing on important features of the structures and devices, so as not to obscure the concept of the present invention. The same reference numbers will be used throughout this specification to refer to the same or like parts.

The embodiments of the present invention can be supported by standard documents of at least one of the IEEE 802 system, the 3GPP system, the 3GPP LTE system, the LTE-Advanced (LTE-A) system, and the 3GPP2 system which are wireless access systems. That is, steps or portions that are not described in the embodiments of the present invention for the sake of clearly describing the spirit of the present invention can be supported by the standard documents. For all terms used in this disclosure, reference can be made to the standard documents.

The following technologies can be applied to a variety of wireless access technologies such as Code Division Multiple Access (CDMA), Frequency Division Multiple Access (FDMA), Time Division Multiple Access (TDMA), Orthogonal Frequency Division Multiple Access (OFDMA), or Single Carrier Frequency Division Multiple Access (SC-FDMA). CDMA may be implemented as a wireless technology (or radio technology) such as Universal Terrestrial Radio Access (UTRA) or CDMA2000. TDMA may be implemented as a wireless technology such as Global System for Mobile communications (GSM)/General Packet Radio Service (GPRS)/Enhanced Data Rates for GSM Evolution (EDGE). OFDMA may be implemented as a wireless technology such as Institute of Electrical and Electronics Engineers (IEEE) 802.11 (Wi-Fi), IEEE 802.16 (WiMAX), IEEE 802-20, or Evolved UTRA (E-UTRA). UTRA is a part of the Universal Mobile Telecommunications System (UMTS). 3rd Generation Partnership Project (3GPP) long term evolution (LTE) is a part of the Evolved UMTS (E-UMTS) which uses E-UTRA. 3GPP LTE employs OFDMA in downlink and employs SC-FDMA in uplink. LTE-Advanced (LTE-A) is an evolution of 3GPP LTE. WiMAX may be explained by the IEEE 802.16e standard (WirelessMAN-OFDMA Reference System) and the advanced IEEE 802.16m standard (WirelessMAN-OFDMA Advanced System). Although the following description focuses on the 3GPP LTE and 3GPP LTE-A system for clarity, the spirit of the present invention is not limited to the 3GPP LTE and 3GPP LTE-A system.

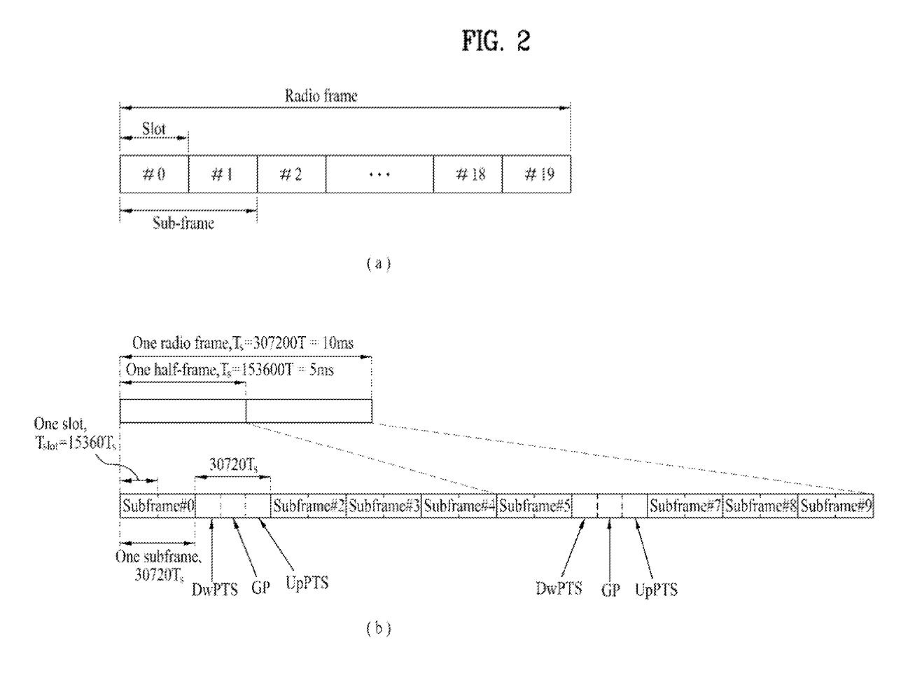

A structure of a downlink radio frame is described below with reference to FIGS. 2(a) and 2(b).

In a cellular OFDM radio packet communication system, uplink/downlink data packets are transmitted in units of subframes and one subframe is defined as a time interval including a plurality of OFDM symbols. The 3GPP LTE standard supports a type-1 radio frame structure which is applicable to Frequency Division Duplex (FDD) and a type-2 radio frame structure which is applicable to Time Division Duplex (TDD).

FIG. 2(A) illustrates a structure of a type-1 radio frame. One downlink radio frame includes 10 subframes, each of which includes two slots. A time required to transmit one subframe is defined as a Transmission Time Interval (TTI). For example, one subframe may have a length of lms and one slot may have a length of 0.5 ms. One slot may include a plurality of OFDM symbols in the time domain and include a plurality of Resource Blocks (RBs) in the frequency domain.

The number of OFDM symbols included in one slot may vary depending on the configuration of a Cyclic Prefix (CP). CPs include an extended CP and a normal CP. For example, in the case where the OFDM symbols are configured using the normal CP, the number of OFDM symbols included in one slot may be 7. In the case where the OFDM symbols are configured using the extended CP, the length of one OFDM symbol is increased such that the number of OFDM symbols included in one slot is less than when the normal CP is used. In the case where the extended CP is used, the number of OFDM symbols included in one slot may be, for example, 6. When the channel state is unstable, for example, when a User Equipment (UE) moves at a high speed, the extended CP may be used in order to further reduce inter-symbol interference.

In the case where the normal CP is used, one subframe includes 14 OFDM symbols since one slot includes 7 OFDM symbols. In this case, the first 2 or 3 OFDM symbols of each subframe may be allocated to a Physical Downlink Control Channel (PDCCH) and the remaining OFDM symbols may be allocated to a Physical Downlink Shared Channel (PDSCH).

FIG. 2(B) illustrates a structure of a type-2 radio frame. A type-2 radio frame includes 2 half frames, each of which includes 5 subframes. Subframes may be classified into general subframes and special subframes. A special subframe includes 3 fields, i.e., Downlink Pilot Time Slot (DwPTS), Gap Period (GP), and Uplink Pilot Tile Slot (UpPTS) fields. Although the lengths of these three fields may be individually set, the total length of the three fields should be lms. One subframe consists of 2 slots. That is, one subframe includes 2 slots, regardless of the type of the radio frame.

The structure of the radio frame is only exemplary and the number of subframes included in the radio frame, the number of slots included in each subframe, or the number of symbols included in each slot may be changed in various manners.

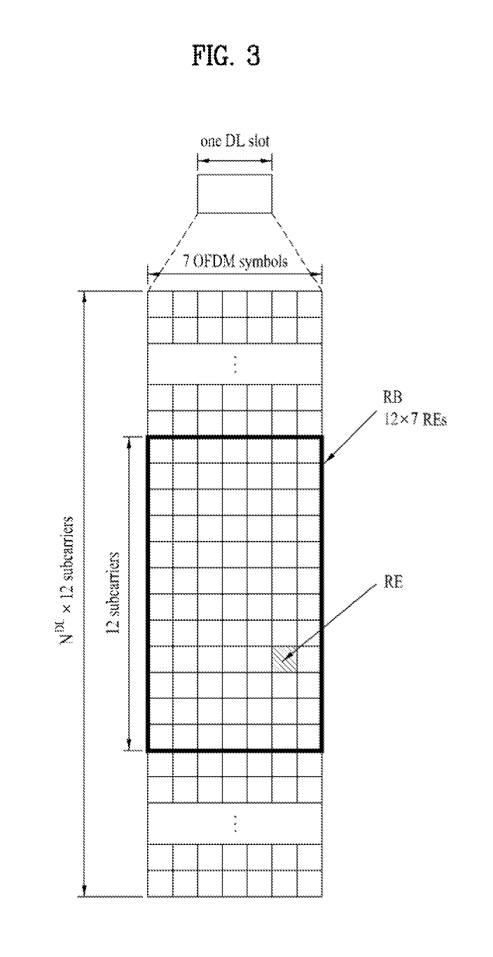

FIG. 3 illustrates a resource grid in a downlink slot. Although one downlink slot includes 7 OFDM symbols in the time domain and one RB includes 12 subcarriers in the frequency domain in the example of FIG. 3, the present invention is not limited to this example. For example, one slot may include 6 OFDM symbols when extended CPs are applied while one slot includes 7 OFDM symbols when normal Cyclic Prefixes (CPs) are applied. Each element on the resource grid is referred to as a resource element (RE). One resource block (RB) includes 12×7 REs. The number of RBs (N^{DL}) included in one downlink slot is determined based on a downlink transmission bandwidth. The structure of the uplink slot may be identical to the structure of the downlink slot.

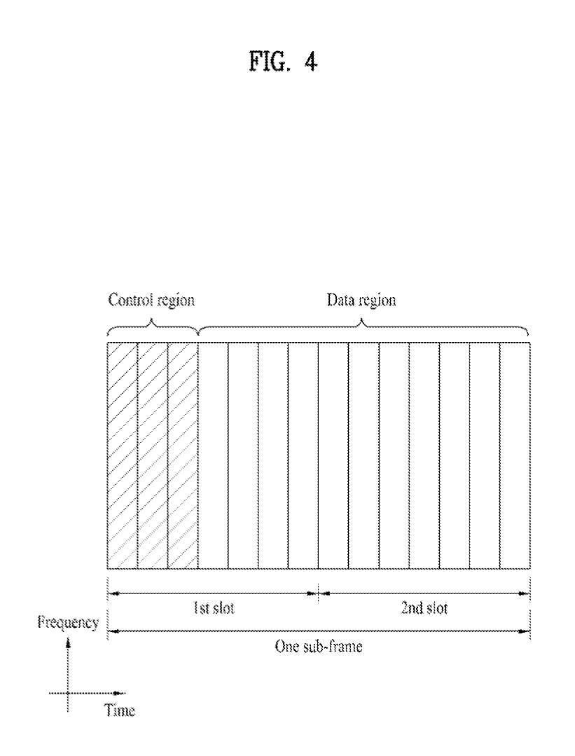

FIG. 4 illustrates the structure of a downlink subframe. Up to the first 3 OFDM symbols of a first slot within one subframe correspond to a control area to which a control channel is allocated. The remaining OFDM symbols correspond to a data area to which a Physical Downlink Shared Channel (PDSCH) is allocated. Downlink control channels used in the 3GPP LTE system include, for example, a Physical Control Format Indicator Channel (PCFICH), a Physical Downlink Control Channel (PDCCH), and a Physical Hybrid Automatic Repeat reQuest (HARQ) Indicator Channel (PHICH). The PCFICH is transmitted in the first OFDM symbol of a subframe and includes information regarding the number of OFDM symbols used to transmit a control channel in the subframe. The PHICH includes a HARQ ACK/NACK signal as a response to uplink transmission. Control information transmitted through the PDCCH is referred to as Downlink Control Information (DCI). The DCI includes uplink or downlink scheduling information or includes an uplink transmission power control command for a UE group. The PDCCH may include a resource allocation and transmission format of a Downlink Shared Channel (DL-SCH), resource allocation information of an Uplink Shared Channel (UL-SCH), paging information of a Paging Channel (PCH), system information of the DL-SCH, information regarding resource allocation of a higher layer control message such as a Random Access Response (RAR) that is transmitted in the PDSCH, a set of transmission power control commands for individual UEs in a UE group, transmission power control information, and information regarding activation of Voice over IP (VoIP). A plurality of PDCCHs may be transmitted within the control area. The UE may monitor the plurality of PDCCHs. The PDCCHs are transmitted in an aggregation of one or more consecutive Control Channel Elements (CCEs). Each CCE is a logical allocation unit that is used to provide the PDCCHs at a coding rate based on the state of a radio channel. The CCE corresponds to a plurality of resource element groups. The format of the PDCCH and the number of available bits are determined based on a correlation between the number of CCEs and a coding rate provided by the CCEs. The base station (eNB) determines the PDCCH format according to a DCI that is transmitted to the UE, and adds a Cyclic Redundancy Check (CRC) to control information. The CRC is masked with a Radio Network Temporary Identifier (RNTI) according to the possessor or usage of the PDCCH. If the PDCCH is associated with a specific UE, the CRC may be masked with a cell-RNTI (C-RNTI) of the UE. If the PDCCH is associated with a paging message, the CRC may be masked with a paging indicator identifier (P-RNTI). If the PDCCH is associated with system information (more specifically, a system information block (SIB)), the CRC may be masked with a system information identifier and a system information RNTI (SI-RNTI). To indicate a random access response that is a response to transmission of a random access preamble from the UE, the CRC may be masked with a random access-RNTI (RA-RNTI).

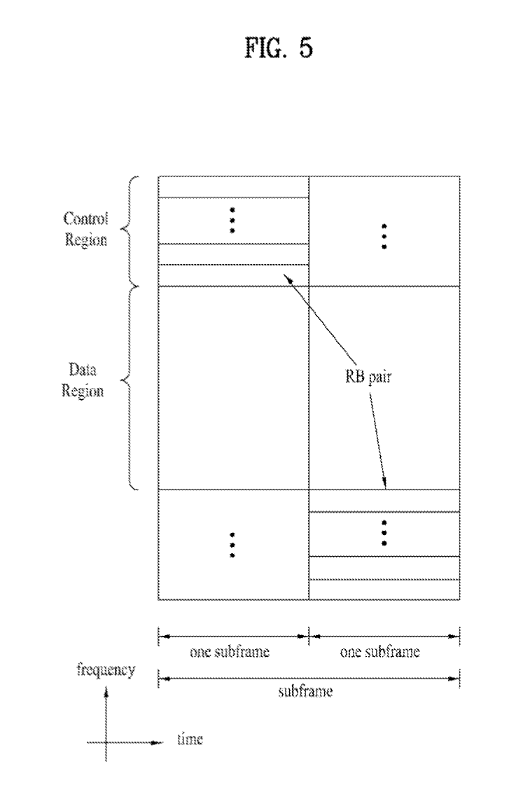

FIG. 5 illustrates the structure of an uplink subframe. The uplink subframe may be divided into a control area and a data area in the frequency domain. A Physical Uplink Control Channel (PUCCH) including uplink control information is allocated to the control area. A Physical Uplink Shared Channel (PUSCH) including user data is allocated to the data area. In order to maintain single carrier properties, one UE does not simultaneously transmit the PUCCH and the PUSCH. A PUCCH associated with one UE is allocated to an RB pair in a subframe. RBs belonging to the RB pair occupy different subcarriers in two slots. That is, the RB pair allocated to the PUCCH is “frequency-hopped” at a slot boundary.

Carrier Aggregation

In a general wireless communication system, typically, a single carrier is considered in uplink and downlink although different bandwidths are set for uplink and downlink. For example, it is possible to provide a wireless communication system based on a single carrier in which the number of carriers constituting each of the uplink and the downlink is 1 and bandwidths of the uplink and the downlink are symmetrical to each other.

The international telecommunication union (ITU) requires that candidate technologies for IMT-Advanced support a bandwidth extended compared to a conventional wireless communication system. However, it is difficult to allocate frequencies of a large bandwidth throughout the world, except for some regions. Thus, as a technology for efficiently using small fragmented bands, a carrier aggregation technology which is also referred to as bandwidth aggregation or spectrum aggregation has been developed to allow a number of physical bands to be combined in the frequency domain to be used as a band having a large logical bandwidth.

Carrier aggregation has been introduced in order to support increased throughput, to prevent cost increase due to introduction of broadband RF elements, and to guarantee compatibility with existing systems. Carrier aggregation enables data exchange between a UE and an eNB through a plurality of groups of bandwidth-based carriers, which are defined in a conventional wireless communication system (for example, in the LTE system in the case of the LTE-A system or in the IEEE 802.16e system in the case of the IEEE 802.16m system). Here, bandwidth-based carriers defined in the conventional wireless communication system may be referred to as component carriers (CCs). A component carrier (CC) may also be referred to as a cell. For example, carriers which are to be subjected to carrier aggregation in downlink may be referred to as a DL-cell and carriers which are to be subjected to carrier aggregation in uplink may be referred to as an UL-cell. Carrier aggregation technologies may include, for example, a technology that combines up to 5 carriers to support system bandwidths of up to 100 MHz even though a single carrier supports a bandwidth of 5 MHz, 10 MHz or 20 MHz.

In the following description of carrier aggregation, the term “base station” or “eNB” may refer to a macro or micro base station or eNB.

Downlink carrier aggregation may be described as support of downlink transmission of an eNB to a UE using frequency-domain resources (for example, subcarriers or Physical Resource Blocks (PRBs)) in bands of one or more carriers in certain time-domain resources (which are, for example, in units of subframes). Uplink carrier aggregation may be described as support of uplink transmission of a UE to an eNB using frequency-domain resources (subcarriers or PRBs) of bands of one or more carriers in certain time-domain resources (which are in units of subframes).

To support carrier aggregation, there is a need to establish a connection or to prepare for connection setup between an eNB and a UE in order to transmit a control channel (PDCCH or PUCCH) and/or a shared channel (PDSCH or PUSCH). For the connection/connection setup for each UE, there is a need to measure and/or report carriers and carriers, which are to be measured and/or reported, may be assigned to the UE. That is, carrier assignment to a specific UE is a process of configuring carriers (or cells) (i.e., a process of setting the number and indices of carriers) for use in downlink/uplink transmission to/from the specific UE from among downlink/uplink carriers (or cells) configured by an eNB, taking into account the capabilities of the specific UE and system environments.

Multi-Input Multi-Output (MIMO) System

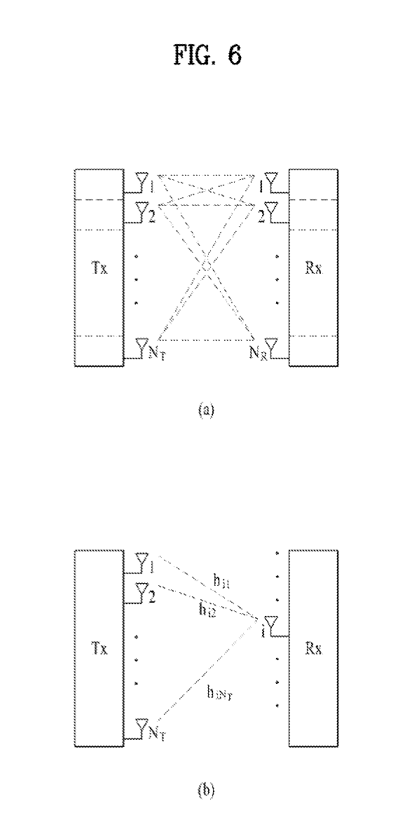

FIG. 6 illustrates the configuration of a wireless communication system having multiple antennas. As shown in FIG. 6(a), if the number of transmit antennas is increased to N_{T} and the number of receive antennas is increased to N_{R}, a theoretical channel transmission capacity is increased in proportion to the number of antennas unlike when a plurality of antennas is used only in a transmitter or a receiver. Accordingly, it is possible to improve transfer rate and to remarkably improve frequency efficiency. As the channel transmission capacity is increased, the transfer rate may be theoretically increased by the product of the maximum transfer rate Ro when a single antenna is used and a rate increase ratio R.

Rᵢ=min(N_{T},N_{R}) Expression 1

For example, in an MIMO system using four transmit antennas and four receive antennas, it is possible to theoretically acquire a transfer rate which is four times that of a single antenna system. After theoretical capacity increase of the multi-antenna system was proven in the mid-90s, various technologies for actually improving data transfer rate have been vigorously studied. In addition, some of such technologies have already been applied to various wireless communication standards such as third-generation mobile communication and next-generation wireless LAN.

Multi-antenna related studies have been conducted in various aspects, such as study of information theory associated with multi-antenna communication capacity calculation in various channel environments and multiple access environments, study of wireless channel measurement and model derivation of a multi-antenna system, study of time-space processing technology for improving transfer rate.

The communication method of the MIMO system will be described in more detail using mathematical modeling. In the above system, it is assumed that N_{T} transmit antennas and N_{R} receive antennas are present.

The maximum number of pieces of information that can be transmitted through transmission signals is N_{T} if N_{T} transmit antennas are present. The transmitted information may be expressed as follows.

s=└s₁,s₂, . . . ,s_{N}_{_{T}}┘^{T} Expression 2

The transmitted information s₁, s₂, . . . , s_{N}_{_{T}} may have different transmission powers. If the respective transmission powers are P₁, P₂, . . . , P_{N}_{_{T}}, the transmitted information with adjusted powers may be expressed as follows.

ŝ=[ŝ₁,ŝ₂, . . . ,ŝ_{N}_{_{T}}]^{T}[P₁s₁,P₂s₂, . . . ,P_{N}_{_{T}}s_{N}_{_{T}}]^{T} Expression 3

In addition, Ŝ may be expressed using a diagonal matrix P of the transmission powers as follows.

$$\begin{matrix}\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] \\ = P s\end{matrix} \qquad Expression 4$$

Let us consider that the N_{T} actually transmitted signals x₁, x₂, . . . , x_{N}_{_{T}} are configured by applying a weight matrix W to the information vector Ŝ with the adjusted transmission powers. The weight matrix W serves to appropriately distribute the transmitted information to each antenna according to the state of a transport channel or the like. x₁, x₂, . . . , x_{N}_{_{T}} may be expressed using the vector X as follows.

$$\begin{matrix}x = [ \begin{matrix}{x}_{1} \\ {x}_{2} \\ ⋮ \\ {x}_{i} \\ ⋮ \\ {x}_{{N}_{T}}\end{matrix} ] \\ = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] \\ = W \hat{s} \\ = WPs ,\end{matrix} \qquad Expression 5$$

where wᵢⱼ denotes a weight between an i-th transmit antenna and j-th information. W is also referred to as a precoding matrix.

If N_{R} receive antennas are present, respective received signals y₁, y₂, . . . , y_{N}_{_{R}} of the antennas are expressed as follows.

y=[y₁,y₂, . . . ,y_{N}_{_{R}}]^{T} Expression 6

If channels are modeled in the MIMO wireless communication system, the channels may be distinguished according to transmit and receive antenna indexes. Let hᵢⱼ represent a channel from the transmit antenna j to the receive antenna i. Note that the indexes of the receive antennas precede the indexes of the transmit antennas in hᵢⱼ.

FIG. 6(b) illustrates channels from the N_{T} transmit antennas to the receive antenna i. The channels may be combined and expressed in the form of a vector and a matrix. In FIG. 6(b), the channels from the N_{T} transmit antennas to the receive antenna i may be expressed as follows.

hᵢ^{T}=[hᵢ₁,hᵢ₂, . . . ,h_{iN}_{_{R}}] Expression 7

Accordingly, all the channels from the N_{T} transmit antennas to the N_{R} receive antennas may be expressed as follows.

$$\begin{matrix}H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] \\ = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ]\end{matrix} \qquad Expression 8$$

An Additive White Gaussian Noise (AWGN) is added to the actual channels after the channels undergo a channel matrix H. The AWGN n₁, n₂, . . . , n_{N}_{_{R added to the N}}_{T} transmit antennas may be expressed as follows.

n=[n₁,n₂, . . . ,n_{N}_{_{R}}]^{T} Expression 9

Through the above-described mathematical modeling, the received signals may be expressed as follows.

$$\begin{matrix}y = [ \begin{matrix}{y}_{1} \\ {y}_{2} \\ ⋮ \\ {y}_{i} \\ ⋮ \\ {y}_{{N}_{R}}\end{matrix} ] \\ = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] \\ = Hx + n\end{matrix} \qquad Expression 10$$

The number of rows and columns of the channel matrix H indicating the channel state is determined by the number of transmit and receive antennas. The number of rows of the channel matrix H is equal to the number N_{R} of receive antennas and the number of columns thereof is equal to the number N_{T} of transmit antennas. That is, the channel matrix H is an N_{R}×N_{T} matrix.

The rank of the matrix is defined as the smallest number of rows or columns which are independent of each other. Accordingly, the rank of the matrix cannot be greater than the number of rows or columns of the matrix. The rank rank(H) of the channel matrix H is restricted as follows.

rank(H)≦min(N_{T},N_{R}) Expression 11

When the matrix is subjected to eigenvalue decomposition, the rank may be defined as the number of eigenvalues excluding 0, Similarly, the rank may also be defined as the number of singular values excluding 0 when the matrix is subjected to singular value decomposition. Accordingly, the physical meaning of the rank in the channel matrix may be considered the maximum number of different pieces of information that can be transmitted in a given channel.

In the description of this disclosure, the ‘rank’ of MIMO transmission indicates the number of paths through which a signal can be independently transmitted at a specific time and a specific frequency resource and the ‘number of layers’ indicates the number of signal streams transmitted through the paths. Generally, since the transmission end transmits a number of layers corresponding to the rank number used for signal transmission, the rank has the same meaning as the number of layers unless specifically stated otherwise.

Coordinated Multi-Point (CoMP)

According to the advanced system performance requirements of the 3GPP LTE-A system, Coordinated Multi-Point (CoMP) transmission/reception technology (which may be referred to as co-MIMO, collaborative MIMO or network MIMO) has been suggested. CoMP technology can increase the performance of a UE located at a cell edge and increase average sector throughput.

In general, in a multi-cell environment whose frequency reuse factor is 1, the performance of the UE located at the cell edge and average sector throughput may be reduced due to Inter-Cell Interference (ICI). In order to reduce ICI, the existing LTE system applies a method in which a UE located at a cell edge acquires appropriate throughput and performance using a simple passive scheme such as Fractional Frequency Reuse (FFR) through UE-specific power control in an environment restricted by interference. However, rather than decreasing the use of frequency resources per cell, it may be preferable that the ICI be reduced or the UE reuse the ICI as a desired signal. A CoMP transmission scheme may be applied in order to accomplish such an object.

The CoMP scheme which is applicable to downlink may be largely classified into a Joint Processing (JP) scheme and a Coordinated Scheduling/Coordinated Beamforming (CS/CB) scheme.

In the JP scheme, each point (eNodeB) of a CoMP unit may use data. The CoMP unit is a set of eNodeBs used in the CoMP scheme. The JP scheme may be classified into a joint transmission scheme and a dynamic cell selection scheme.

The joint transmission scheme is a method in which a PDSCH is simultaneously transmitted from a plurality of points (all or part of the CoMP unit). That is, data destined for a single UE may be simultaneously transmitted from a plurality of transmission points. According to the joint transmission scheme, it is possible to coherently or non-coherently improve the quality of received signals and to actively eliminate interference with another UE.

The dynamic cell selection scheme is a method in which a PDSCH is transmitted from one point (of the CoMP unit). That is, data destined for a single UE is transmitted from one point at a specific time and the other points in the CoMP unit do not transmit data to the UE at that time. The point for transmitting the data to the UE may be dynamically selected.

According to the CS/CB scheme, CoMP units may cooperatively perform beamforming of data transmission to a single UE. Here, although only the serving cell transmits data, user scheduling/beamforming may be determined by coordination of the cells of the CoMP unit.

In uplink, the term “coordinated multi-point reception” refers to reception of a signal transmitted by coordination of a plurality of geographically separated points. The CoMP scheme which is applicable to uplink may be classified into Joint Reception (JR) and Coordinated Scheduling/Beamforming (CS/CB).

The JR scheme is a method in which a plurality of reception points receives a signal transmitted through a PUSCH and the CS/CB scheme is a method that only one point receives a PUSCH and user scheduling/beamforming is determined by the coordination of the cells of the CoMP unit.

Channel Status Information Feedback

The MIMO scheme may be classified into an open-loop scheme and a closed-loop scheme. The open-loop MIMO scheme is a method in which a MIMO transmitting end performs MIMO transmission since no Channel Status Information (CSI) feedback is received from a MIMO receiving end. The closed-loop MIMO scheme is a method in which a MIMO transmitting end receives CSI feedback from the MIMO receiving end and performs MIMO transmission. In the closed-loop MIMO scheme, each of the transmitting and receiving ends may perform beamforming based on CSI in order to acquire multiplexing gain of MIMO transmit antennas. For example, in the case in which downlink CSI is fed back, an eNB may allocate a PUCCH or PUSCH to a UE to allow the UE to feed CSI back to the eNB and instruct the UE to feed CSI of a downlink channel back through the allocated channel.

The fed-back CSI may include a Rank Indicator (RI), a Precoding Matrix Index (PMI), and a Channel Quality Indicator (CQI).

The RI is information regarding channel rank. The channel rank is the maximum number of layers (or streams) through which different information can be transmitted through the same time-frequency resource. Since the RI is determined mainly by long term fading of the channel, the RI may be generally fed back at intervals of a longer period (i.e., less frequently) than the PMI and CQI.

The PMI is information regarding a precoding matrix used for transmission from the transmitting end and reflects spatial characteristics of the channel. The term “precoding” refers to mapping of a transmission layer to a transmit antenna and a layer-antenna mapping relationship may be determined by the precoding matrix. The PMI is a precoding matrix index of the eNB that the UE prefers based on a metric such as a Signal-to-Interference plus Noise Ratio (SINR). To reduce feedback overhead of the precoding information, it is possible to use a method in which the transmitting end and the receiving end share a codebook including a number of precoding matrices and only an index indicating a specific precoding matrix among the precoding matrices of the codebook is fed back.

The CQI is information indicating channel quality or channel strength. The CQI may be expressed as a predetermined Modulation and Coding Scheme (MCS) combination. That is, a CQI index that is fed back indicates a corresponding modulation scheme and code rate. Generally, the CQI has a value that reflects a received SINR that an eNB can acquire when configuring a spatial channel using the PMI.

In relation with CQI measurement, the UE may calculate a channel state or a valid SINR using a downlink reference signal (Cell-specific Reference Signal (CRS)) or a CSI-Reference Signal (CSI-RS). The channel state or the valid SINR may be measured on an overall system bandwidth (which may be referred to as a set S) or may be measured on a partial bandwidth (a specific subband or a specific RB). A CQI of the overall system bandwidth (set S) may be referred to as a Wideband (WB) CQI or a CQI of the partial bandwidth may be referred to as a Subband (SB) CQI. The UE may obtain a highest MCS based on the calculated channel state or valid SINR. The highest MCS is an MCS which satisfies the assumption of CQI calculation while its transport block error rate during decoding does not 10%. The UE may determine a CQI index associated with the obtained MCS and may report the determined CQI index to the eNB.

Methods of reporting such channel information is classified into a periodic reporting method in which channel information is transmitted at regular intervals and an aperiodic reporting method in which channel information is transmitted at the request of the eNB.

In the case of aperiodic reporting, such a CQI request may be set for each UE by a CQI request bit included in uplink scheduling information that the eNB transmits to each UE and each UE may then transmit channel information, which is generated taking into consideration a transmission mode of the UE to the eNB through a Physical Uplink Shared Channel (PUSCH) upon receiving the uplink scheduling information. An RI and a CQI/PMI may be set such that the RI and CQI/PMI are not transmitted on the same PUSCH.

In the case of periodic reporting, information such as a period at intervals of which channel information is transmitted through a higher layer signal and an offset of the period may be signaled to each UE and channel information generated in consideration of the transmission mode of each UE may be provided to the eNB through a Physical Uplink Control Channel (PUCCH). When data which is also transmitted in uplink is also present in a subframe in which channel information is transmitted at intervals of a fixed period, the channel information may be transmitted together with the data through a Physical Uplink Shared Channel (PUSCH) rather than through the PUCCH. Bits which may be used in the case of periodic reporting through a PUCCH may be limited compared to bits which may be used in the case of periodic reporting through a PUSCH. An RI and a CQI/PMI may be transmitted through the same PUSCH. When periodic reporting and aperiodic reporting collide in the same subframe, only aperiodic reporting may be performed.

On the other hand, in a system that supports an extended antenna configuration (for example, an LTE-A system), it is being considered that additional multi-user diversity is obtained using a Multi-User-MIMO (MU-MIMO) scheme. In the MU-MIMO scheme, an interference channel is present between UEs which are multiplexed in the antenna domain and therefore, when an eNB performs downlink transmission using CSI fed back by one of the users, the eNB needs to prevent interference to other UEs. Thus, to properly perform the MU-MIMO operation, there is a need to feed back CSI with higher accuracy than the Single-User-MIMO (SU-MIMO) scheme.

It is possible to apply a new CSI feedback scheme which improves conventional CSI including an RI, a PMI, and a CQI to enable more accurate CSI measurement and reporting. For example, precoding information fed back by the receiving end may be indicated by a combination of 2 PMIs. One of the 2 PMIs (1st PMI) may have an attribute of a long term and/or wideband and may be referred to as W1. The other of the 2 PMIs (2nd PMI) may have an attribute of a short term and/or subband and may be referred to as W2. A final PMI may be determined by a combination (or function) of W1 and W2. For example, when the final PMI is W, W may be defined such that W=W1*W2 or W=W2*W1.

Here, the W1 reflects average channel characteristics in frequency and/or time. That is, the W1 may be defined as channel status information which reflects characteristics of a long term channel in time, reflects characteristics of a wideband channel in frequency, or reflects characteristics of a channel which is both a long term channel in time and a wideband channel in frequency. In order to simply express such characteristics of the W1, the W1 is referred to as CSI having a long-term-wideband attribute (or long-term-wideband PMI) in this disclosure.

On the other hand, the W2 reflects instantaneous channel characteristics compared to the W1. That is, the W2 may be defined as channel status information which reflects characteristics of a short term channel in time, reflects characteristics of a subband channel in frequency, or reflects characteristics of a channel which is both a short term channel in time and a subband channel in frequency. In order to simply express such characteristics of the W2, the W2 is referred to as CSI having a short-term-subband attribute (or short-term-subband PMI) in this disclosure.

In order to allow one final precoding matrix (W) to be determined from information (for example, W1 and W2) of 2 different attributes representing channel states, there is a need to configure respective codebooks including precoding matrices representing respective channel information of the attributes (i.e., a first codebook of W1 and a second codebook of W2). Codebooks configured in this manner are referred to as hierarchical codebooks. Determination of a codebook, which is to be finally used, using the hierarchical codebooks may be referred to as hierarchical codebook transformation.

In an exemplary hierarchical codebook transformation scheme, a codebook may be transformed using a long term covariance matrix of channel as shown in the following Expression 12.

W−norm(W1W2) Expression 12

In Expression 12, W1 (long-term-wideband PMI) represents an element that constitutes a codebook (for example, the first codebook) generated to reflect channel information of the long-term-wideband attribute. That is, W1 corresponds to a precoding matrix included in the first codebook that reflects channel interference of the long-term-wideband attribute. W2 (short-term-subband PMI) represents an element that constitutes a codebook (for example, the second codebook) generated to reflect channel information of the short-term-subband attribute. That is, W2 corresponds to a precoding matrix included in the second codebook that reflects channel interference of the short-term-subband attribute. W represents a codeword of the final codebook produced through such conversion. Norm(A) indicates that the norm of each column of the matrix A is normalized to 1.

For example, W1 and W2 may be designed into a structure as shown in the following Expression 13.

$$W 1 ( i ) = [ \begin{matrix}{X}_{i} & 0 \\ 0 & {X}_{i}\end{matrix} ] , \\ where \\ {X}_{i} is Nt \text{/} 2 by M matrix . \\ W 2 ( j ) = {\overbrace{[ \begin{matrix}{e}_{M}^{k} & {e}_{M}^{l} & {e}_{M}^{m} \\ & & … \\ {α}_{j} {e}_{M}^{k} & {β}_{j} {e}_{M}^{l} & {γ}_{j} {e}_{M}^{m}\end{matrix} ]}}^{r columns} ( if rank = r ) , \\ where \\ 1 \leq k , l , m \leq M \\ and \\ k , l , m are integer . \qquad Expression 13$$

In Expression 13, W1 may be defined in the form of a block diagonal matrix, each block may correspond to the same matrix, and one block Xᵢ may be defined as an (Nt/2)×M matrix. Here, Nt is the number of transmit antennas. In W2, eⱼⁱ represents a j×1 vector whose ith element is 1 with the remaining elements being 0. When eⱼⁱ is multiplied by W1, the ith column of W1 is selected and therefore this vector may be referred to as a selection vector. In W2, αⱼ,βⱼ, and γⱼ represent phase values.

The codebook structure of Expression 13 is designed so as to well reflect correlation characteristics of a channel generated when the interval between each antenna is small (generally, when the distance between adjacent antennas is less than or equal to one half of the signal wavelength) while a cross polarized (X-pol) antenna configuration is used. For example, 2Tx cross-polarized antennas may include two antenna groups (antenna groups 1 and 2) having orthogonal polarizations and antennas of antenna group 1 (antennas 1, 2, 3, and 4) may have the same polarization (for example, the same vertical polarization) and antennas of antenna group 2 (antennas 5, 6, 7, and 8) may have the same polarization (for example, the same horizontal polarization). The two antenna groups are located at the same position (i.e., are co-located). For example, antennas 1 and 5 may be installed at the same position, antennas 2 and 6 may be installed at the same position, antennas 3 and 7 may be installed at the same position, and antennas 4 and 8 may be installed at the same position. Namely, antennas in one antenna group have the same polarization similar to a Uniform Linear Array (ULA) and the correlation between antennas in one antenna group has linear phase increment characteristics. The correlation between antenna groups has phase rotation characteristics.

Since a codebook has a quantized value of a channel, there is a need to reflect the characteristics of an actual channel to design the codebook. A codebook of rank 1 is described below as an example in order to explain that the characteristics of an actual channel have been reflected in a codebook designed as shown in Expression 13. The following Expression 14 illustrates an example in which a final codeword (W) is determined to be the product of a codeword of W1 and a codeword of W2 in the case of rank 1.

$$W 1 ( i ) * W 2 ( j ) = [ \begin{matrix}{X}_{i} ( k ) \\ {α}_{j} {X}_{i} ( k )\end{matrix} ] \qquad Expression 14$$

In Expression 14, a codeword is expressed by a Nt×1 vector and has a structure of two vectors, an upper vector (Xᵢ(k)) and a lower vector (αⱼXᵢ(k)). The upper vector (Nᵢ(k)) represents correlation characteristics of a horizontally-polarized antenna group of a cross-polarized antenna and the lower vector (αⱼXᵢ(k)) represents correlation characteristics of a vertically-polarized antenna group thereof. Here, preferably, Xⱼ(k) reflect correlation characteristics between antennas in each antenna group and is expressed as a vector (for example, a DFT matrix) having linear phase increment characteristics.

CSI feedback (specifically, a PMI) representing more accurate channel characteristics may also be useful in a wireless communication system that operates according to a CoMP scheme. For example, a CoMP JT system may be theoretically regarded as a MIMO system in which antennas are geographically distributed since a number of eNBs transmit the same data to a specific UE in a cooperative manner in the CoMP JT system. That is, when MU-MIMO is performed according to the CoMP JT scheme, a higher level of channel accuracy is needed to avoid interference between UEs that are co-scheduled, similar to single-cell MU-MIMO. In the CoMP CB scheme, accurate channel information is also needed to avoid interference that an adjacent cell causes to a serving cell. Accordingly, the CSI feedback scheme described above may also be applied to the CoMP system in order to achieve feedback of channel information with higher accuracy.

Uplink Power Control

The purpose of power control in a wireless communication system is to compensate for channel path loss and fading to guarantee Signal-to-Noise Ratio (SNR) required for the system and to provide higher system performance through appropriate rank adaptation. Inter-cell interference may also be adjusted by power control.

Uplink power control in the conventional system is based on closed-loop correction and/or open-loop power control. Open-loop power control is performed by calculation of a User Equipment (UE) and closed-loop correction is performed by a power control command from an evolved Node B (eNB). A Transmit Power Control (TPC) command from the eNB may be defined in a DCI format of a PDCCH.

A power control procedure is described below with reference to the case of single transmit antenna transmission as an example.

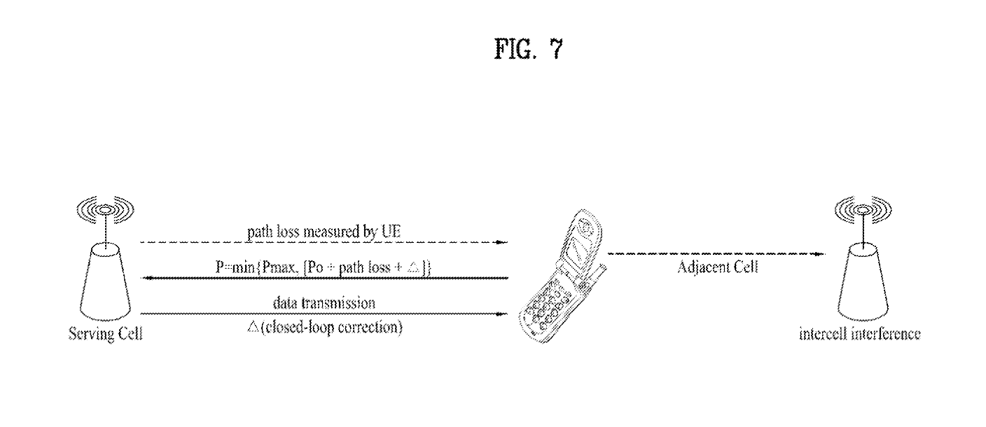

FIG. 7 illustrates a basic concept of uplink power control. A UE generally measures uplink power using a closed-loop scheme and an eNB may adjust uplink power by a closed-loop correction factor Δ. Power control of an uplink shared channel (PUSCH) may be performed according to the following Expression 15.

P_{PUSCH}(i)=min{P_{CMAX},10 log₁₀(M_{PUSCH}(i))+P_{O}_{_{—}}_{PUSCH}(j)+α(j)·PL+Δ_{TF}(i)+f(i)} Expression 15

In Expression 15, P_{PUSCH}(i) represents transmission power of an ith subframe of a PUSCH and is in units of dBm. P_{CMAX} represents maximum allowable power which is set by a higher layer and is determined according to the class of the UE. M_{PUSCH}(i) represents the amount of allocated resources and may be expressed in units of allocated resource blocks (each being a group of subcarriers, for example, 12 subcarriers). M_{PUSCH} (i) has a value between 1 and 110 and is updated every subframe. In Expression 15, P_{O}_{_{—}}_{PUSCH}(j) includes 2 parts, P_{O}_{_{—}}_{NOMINAL}_{_{—}}_{PUSCH}(j) and P_{O}_{_{—}}_{UE}_{_{—}}_{PUSCH}(j), as shown in the following Expression 16.

P_{O}_{_{—}}_{PUSCH}(j)+P_{O}_{_{—}}_{NOMINAL}_{_{—}}_{PUSCH}(j)+P_{O}_{_{—}}_{UE}_{_{—}}_{PUSCH}(j) Expression 16

In Expression 16, P_{O}_{_{—}}_{NOMINAL}_{_{—}}_{PUSCH}(j) is a value which is given cell-specifically by the higher layer and P_{O}_{_{—}}_{UE}_{_{—}}_{PUSCH}(j) is a value which is given UE-specifically by the higher layer.

In Expression 15, argument j may have a value of 0, 1, or 2. When j=0, the argument j corresponds to PUSCH transmission which is scheduled dynamically in a PDCCH. When j=1, the argument j corresponds to semi-persistent PUSCH transmission. When j=2, the argument j corresponds to PUSCH transmission based on a random access grant.

In Expression 15, α(j)·PL is a term for path loss compensation. Here, PL represents downlink path loss measured by the UE and is defined as “reference signal power—higher layer filtered Reference Signal Received Power (RSRP)”. α(j) is a scaling value representing a path loss correction ratio, has one of the values of {0, 0.4, 0.5, 0.6, 0.7, 0.8, 0.9, 1}, and is expressed by a 3-bit value. When α is 1, this indicates that the path loss has been fully compensated for and, when α is less than 1, this indicates that the path loss has been partially compensated for.

Δ_{TF}(i) in Expression 15 may be given by the following Expression 17.

$$Expression 17$$

$${Δ}_{TF} ( i ) = \{ \begin{matrix}10 {log}_{10} ( {2}^{MPR \cdot {K}_{s}} - 1 ) , & {K}_{s} = 1.25 , deltaMCS - Enabled = 1 \\ 0 , & {K}_{s} = 0 , deltaMCS - Enabled = 0\end{matrix}$$

As shown in Expression 17, use of Δ_{TF}(i) may be set by a flag “deltaMCS-Enabled”. When the flag deltaMCS-Enabled has a value of 1, Δ_{TF}(i) is set to be used. When the flag deltaMCS-Enabled has a value of 0, Δ_{TF}(i) is not used since Δ_{TF}(i) has a value of 0. MPR in Expression 17 may be given by the following Expression 18.

MPR=TBS/N_{RE},N_{RE}=M_{PUSCH}·N_{sc}^{RB}·N_{symb}^{PUSCH} Expression 18

In Expression 18, TBS stands for a transport block size and N_{RE} is the number of Resource Elements (REs) which is expressed as the number of subcarriers. When data is retransmitted, the value of N_{RE} may be acquired from a value indicated by a first PDCCH for the same transport block.

f(i) in Expression 15 represents a parameter for adjusting transmission power according to a closed-loop scheme. A PDCCH of DCI format 0, 3, or 3A may be used to provide f(i). That is, f(i) is a parameter that is given UE-specifically. In association with f(i), a flag “Accumulation_Enabled” may indicate whether a transmission power value is given through accumulation of the previous transmission power or is given without accumulation of the previous transmission power.

When the flag “Accumulation_Enabled” is set to enable the accumulation mode, f(i) may be given as shown in the following Expression 19

f(i)=f(i−1)+δ_{PUSCH}(i−K_{PUSCH}) Expression 19

In Expression 19, δ_{PUSCH} is a UE-specific correction value and may be referred to as a Transmit Power Control (TPC) command. δ_{PUSCH} may be included in a PDCCH of DCI format 0 to be signaled to the UE or may be joint-coded together with other TPC commands into a PDCCH of DCI format 3/3A to be signaled to the UE. An accumulated value of δ_{PUSCH} dB which is signaled in a PDCCH of DCI format 0 or 3 may have a size of 2 bits as shown in the following Table 1.

TABLE 1

| TPC Command Field in DCI | |
|---|---|
| format 0/3 | Accumulated δ_{PUSCH} [dB] |
| 0 | −1 |
| 1 | 0 |
| 2 | 1 |
| 3 | 3 |

When the UE detects PDCCH DCI format 3A, the accumulated value of δ_{PUSCH} dB is represented by 1 bit and may have one of the values of {−1, 1}.

In Expression 19, K_{PUSCH}=4 in the case of FDD.

When both DCI format 0 and DCI format 3/3A are detected in the same subframe, the UE uses δ_{PUSCH} that is provided by DCI format 0. When a TPC command is absent or in the case of a discontinuous reception (DRX) mode, δ_{PUSCH}=0 dB. When the transmission power of the UE reaches the maximum transmission power, a TPC command having a positive value is not accumulated (i.e., the maximum transmission power is maintained). When the transmission power of the UE reaches the minimum transmission power, a TPC command having a negative value is not accumulated (i.e., the minimum transmission power is maintained).

On the other hand, when the flag “Accumulation_Enabled” is set to disable the accumulation mode, f(i) may be given as shown in the following Expression 20. The disabled accumulation mode means that the uplink power control value is given as an absolute value.

f(i)=δ_{PUSCH}(i−K_{PUSCH}) Expression 20

In Expression 20, the value of δ_{PDSCH} is signaled only in the case of PDCCH DCI format 0. Here, the value of δ_{PDSCH} may be given as shown in the following Table 2.

TABLE 2

| TPC Command Field | Absolute δ_{PUSCH} [dB] only |
|---|---|
| in DCI format 0 | DCI format 0 |
| 0 | −4 |
| 1 | −1 |
| 2 | 1 |
| 3 | 4 |

In Expression 20, K_{PUSCH}=4 in the case of FDD.

f(i)=f(i−1) when a PDCCH is detected, when the current mode is a DRX mode, or when the current subframe is not an uplink subframe in TDD.

Power control for an uplink control channel (PUCCH) may be defined as shown in the following Expression 21.

P_{PUCCH}(i)=min{P_{CMAX},P₀_{_{—}}_{PUCCH}+PL+h(n_{CQI},n_{HARQ})+Δ_{F}_{_{—}}_{PUCCH}(F)+g(i)} Expression 21

In Expression 21, P_{PUCCH}(i) is expressed in units of dBm. In Expression 21, Δ_{F}_{_{—}}_{PUCCH}(F) is provided by the higher layer and each Δ_{F}_{_{—}}_{PUCCH}(F) corresponds to a) PUCCH format (F) associated with PUCCH format 1a. The value h(n_{CQI}, n_{HARQ}) depends on the PUCCH format, n_{CQI} corresponds to a number information bit for Channel Quality Information (CQI), and n_{HARQ} corresponds to the number of Hybrid Automatic Repeat reQuest (HARQ) bits.

The following Expression 22 is satisfied for PUCCH formats 1, 1a, and 1b.

h(n_{CQI},n_{HARQ}) Expression 22

The following Expression 23 is satisfied for PUCCH formats 2, 2a, and 2b and a normal cyclic prefix.

$$h ( {n}_{CQI} , {n}_{HARQ} ) = \{ \begin{matrix}10 {log}_{10} ( \frac{{n}_{CQI}}{4} ) & if {n}_{CQI} \geq 4 \\ 0 & otherwise\end{matrix} \qquad Expression 23$$

The following Expression 24 is satisfied for PUCCH format 2 and an extended cyclic prefix.

$$Expression 24$$

$$h ( {n}_{CQI} , {n}_{HARQ} ) = \{ \begin{matrix}10 {log}_{10} ( \frac{{n}_{CQI} + {n}_{HARQ}}{4} ) & if {n}_{CQI} + {n}_{HARQ} \geq 4 \\ 0 & otherwise\end{matrix}$$

On the other hand, P_{O}_{_{—}}_{PUCCH}(j) is a parameter that consists of the sum of P_{O}_{_{—}}_{NOMINAL} _{_{—}}_{PUCCH}(j) and P_{O}_{_{—}}_{NOMINAL} _{_{—}}_{SPECIFIC}(j), P_{O}_{_{—}}_{NOMINAL} _{_{—}}_{PUSCH}(j) is provided cell-specifically by the higher layer, and P_{O}_{_{—}}_{UE}_{_{—}}_{SPECIFIC}(j) is given UE-specifically by the higher layer.

g(i) in the above Expression 21 represents a current PUCCH power control adjustment state and is calculated by the following Expression 25.

$$g ( i ) = g ( i - 1 ) + {\sum }_{m = 0}^{M - 1} {δ}_{PUCCH} ( i - {k}_{m} ) \qquad Expression 25$$

In Expression 25, δ_{pucch} is a UE-specific correction value and is also referred to as a Transmission Power Control (TPC). δ_{pucch} is included together with a DCI format in a PDCCH. δ_{pucch} is coded together with a PUCCH correction value specific to another UE and is transmitted together with DCI format 3/3A in a PDCCH. A CRC parity bit of DCI format 3/3A is scrambled together with a TPC-PUCCH-Radio Network Temporary Identifier (RNTI).

On the other hand, power control of a Sounding Reference Signal (SRS) is performed as shown in the following Expression 26.

P_{SRS}(i)=min{P_{CMAX},P_{SRS}_{_{—}}_{OFFSET}+10 log₁₀(M_{SRS}+P_{O}_{_{—}}_{PUSCH}(j)+α(j)·PL+f(i)} Expression 26

In Expression 26, P_{SRS}(i) is expressed in dB. i denotes a time index (or subframe index) and P_{CMAX} represents the maximum allowable power, which is determined according to the class of the UE. P_{SRS}_{_{—}}_{OFFSET} is a 4-bit UE-specific parameter that is set semi-statically by the higher layer. M_{SRS} corresponds to the bandwidth of SRS transmission in subframe i represented by the number of resource blocks. f(i) is a function representing current power control adjustment for a PUSCH. P_{O}_{_{—}}_{PUCCH}(j) is a parameter that consists of the sum of P_{O}_{_{—}}_{NOMINAL}_{_{—}}_{PUCCH}(j) and P_{O}_{_{—}}_{NOMINAL}_{_{—}}_{SPECIFIC}(j), P_{O}_{_{—}}_{NOMINAL}_{_{—}}_{PUSCH}(j) is provided cell-specifically by the higher layer, and P_{O}_{_{—}}_{UE}_{_{—}}_{SPECIFIC}(j) is given UE-specifically by the higher layer. Here, 1 is given as the value of j for PUSCH transmission (or retransmission) corresponding to a dynamically scheduled uplink grant (which is control information for scheduling uplink transmission and is defined by PDCCH DCI format 0 or the like). α(j)·PL is a term for path loss compensation. Here, PL represents downlink path loss measured by the UE and α is a scaling value which is equal to or less than 1 and is expressed by a 3-bit value. When α is 1, this indicates that the path loss has been fully compensated for and, when α is less than 1, this indicates that the path loss has been partially compensated for. When j is 1, αε{0, 0.4, 0.5, 0.6, 0.7, 0.8, 0.9, 1} is a 3-bit cell-specific parameter provided by the higher layer. PL is a downlink path loss measurement value which is calculated by the UE and is in units of dB.

Uplink Transmission Power Control in Consideration of Interference

As described above, in a heterogeneous network environment in which a macro eNB and micro eNB are present together, serious intercell interference may occur compared to a homogeneous network environment in which only a macro eNB (or only a micro eNB) is present. For example, a downlink (DL) serving cell (for example, a macro eNB) selected based on received signal power may differ from an uplink (UL) serving cell (for example, a micro eNB) selected based on path loss due to the maximum transmission power difference of the eNBs.

For example, let us assume that a UE is located more adjacent to a micro eNB than to a macro eNB. Transmission power of the macro eNB is higher than transmission power of the micro eNB. Therefore, even when the UE is located more adjacent to the micro eNB, the macro eNB may be selected as a serving cell since the strength of downlink signal from the macro eNB may be higher than the strength of downlink signal from the micro eNB. In this case, since the distance between the UE and the macro eNB is great, the UE may transmit an uplink signal to the macro eNB with higher transmission power in order to compensate for such a great distance. Here, such uplink transmission with high power may cause high interference to the micro eNB which is adjacent to the UE.

That is, in the case in which a DL serving cell and a UL serving cell are determined with reference to received signal power of a UE, a UL signal of a macro UE may cause strong interference to a micro eNB if the macro UE which is being served by a macro eNB is more adjacent to the micro eNB than to the macro eNB. Similarly, intercell interference may occur in a DL channel between the micro eNB and the macro eNB since the distance between the UE and the interfering cell is small.

In addition, serious interference may occur when a macro UE enters the coverage of a CSG micro eNB which is configured to serve only a specific UE since the macro UE cannot receive DL/UL services from the micro eNB and still communicates with the macro eNB even though the macro UE has entered the coverage of the micro eNB. For example, when a specific macro UE has approached a micro eNB which operates in a CSG mode, an uplink signal that the UE transmits to the macro eNB causes serious interference to uplink of the micro eNB.

In order to overcome such a problem, interference coordination may be performed in the time domain. In the following description, a cell which causes interference is referred to as an interfering cell and a cell which receives interference is referred to as a victim cell.

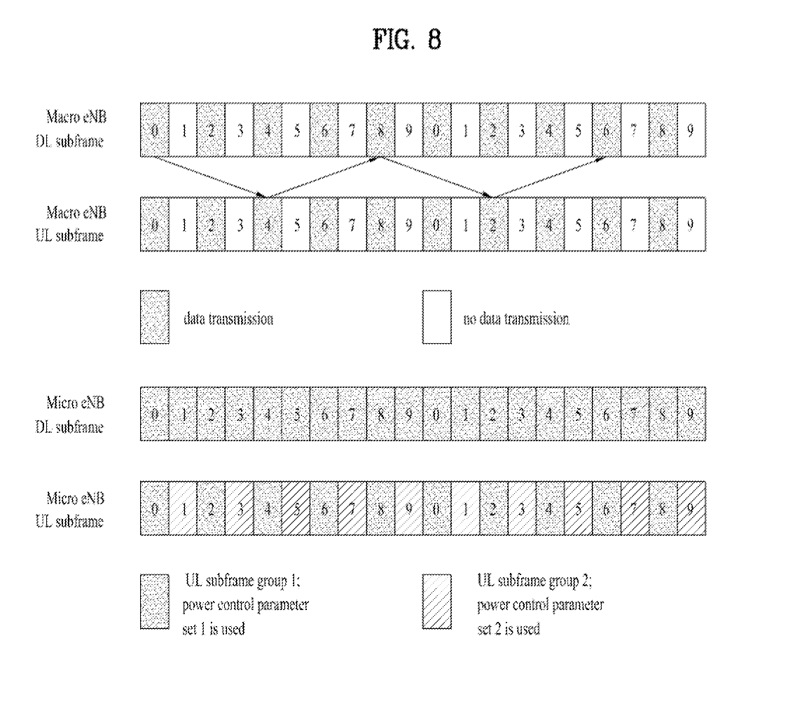

FIG. 8 illustrates an example of time domain interference coordination. In the example of FIG. 8, it is assumed that the subframe timings of an interfering cell and a victim cell have been aligned.

For example, in the case in which interference coordination is performed in the time domain, the interfering cell may set transmission such that DL/UL transmission is not performed or only a minimal (or necessary) control signal excluding data is transmitted on a specific time unit basis (for example, on the basis of one or more OFDM symbols, one or more slots, or one or more subframes). In this case, the victim cell receives interference of less than a specific threshold in a group of time units in which the interfering cell performs interference coordination and receives interference of a specific threshold or higher in a group of time units in which the interfering cell does not perform interference coordination. Thus, the victim cell may perform UL power control optimized for each of the group of time units in which the interfering cell performs interference coordination and the group of time units in which the interfering cell does not perform interference coordination.

In a specific example, as shown in FIG. 8, the macro eNB which is the interfering cell may set partial subframes (for example, subframes of odd indices) as coordinated subframes and set transmission such that DL/UL transmission is not performed or only a minimal control signal excluding data is transmitted in the subframes.

As signal transmission is performed or not in a subframe of the macro eNB as described above, the micro eNB (such as a pico eNB or a home eNB) which is a victim cell may experience different interference levels (for example, Interference over Thermal (IoT) levels) in a subframe of an even index and a subframe of an odd index. Accordingly, to achieve optimal uplink performance according to an uplink interference level which changes in an uplink subframe, the micro eNB may perform optimized uplink power control for each subframe group (for each of group 1 which includes subframes of even indices and group 2 which includes subframes of odd indices).

In another example, when the micro eNB sets partial subframes as coordinated subframes (i.e., when the micro eNB sets subframes such that transmission is to be performed or not in each subframe), the macro eNB may perform optimized uplink power control according to each subframe group.

On the other hand, interference coordination may be performed in the frequency domain. For example, the interfering cell may set transmission such that DL/UL transmission is not performed or only a minimal control signal excluding data is transmitted on a specific frequency unit basis (for example, on the basis of one or more subcarriers or one or more Resource Blocks (RBs)). In this case, the victim cell may perform UL power control optimized for each of the group of frequency units in which the interfering cell performs interference coordination and the group of frequency units in which the interfering cell does not perform interference coordination.

On the other hand, interference coordination may be performed for each of the time domain and the frequency domain. For example, the interfering cell may perform interference coordination on the basis of the time unit described above (for example, on an OFDM symbol, slot, or subframe basis and on the basis of the frequency unit (for example, on a subcarrier or RB basis) and the victim cell may perform optimal UL power control for each of a resource region group in which the interfering cell performs interference coordination and a resource region group in which the interfering cell does not perform interference coordination.

In the case in which carrier aggregation is applied, interference coordination may be performed on a carrier (CC or cell) basis. For example, the interfering cell may perform interference coordination on a specific carrier (or carrier group) basis and the victim cell may perform optimal UL power control for carrier(s) in which the interfering cell performs interference coordination and for carrier(s) in which the interfering cell does not perform interference coordination.

In the case in which a specific cell does not perform DL/UL transmission or transmits only a minimal control signal excluding data in a specific resource region (time and/or frequency domain) for the purpose of avoiding interference with an adjacent cell and the adjacent cell undergoes a rapid change in the interference level over a number of resource regions, the adjacent cell may perform optimized uplink transmission power control for each resource region group. Various examples in which a specific cell performs uplink power control taking into consideration interference coordination of an adjacent cell as described above are described below.

In the following, various methods of the present invention are described with reference to a PUSCH transmission power control method as an example for clarity of explanation. However, the present invention is not limited to the PUSCH transmission power control method and the principle of the present invention may be equally applied to PUCCH power control and/or SRS power control.

Uplink Power Control in Time Domain

Although the following description will be given with reference to an example in which uplink power control is performed on a subframe (or subframe group) basis for clarity of explanation, the present invention is not limited to this example and the principle of the present invention may be equally applied to the case in which uplink power control is performed on a specific time resource unit basis (for example, on an OFDM symbol basis or on a slot basis).

For ease of explanation, the PUSCH power control equation described in the above Expression 15 is rewritten as the following Expression 27.

P_{PUSCH}(i)=min{P_{CMAX},10 log₁₀(M_{PUSCH}(i))+P_{O}_{_{—}}_{PUSCH}(j)+α(j)·PL+Δ_{TF}(i)+f(i)} Expression 27

A detailed description of Expression 27 is omitted herein since it is the same as Expression 15. A detailed method for controlling uplink transmission power when uplink power control is performed using the method of Expression 27 or a similar method.

Parameters associated with uplink power control as shown in Expression 27 may be largely divided into parameters that are semi-statically determined through Radio Resource Control (RRC) signaling and parameters that are dynamically determined through a TPC command through a PDCCH.

Accordingly, each parameter may be changed semi-statically or dynamically to perform uplink power control optimized for each subframe group according to the method of Expression 27. Here, subframe groups are divided into a subframe group in which interference coordination by an interfering cell is applied and a subframe group in which no interference coordination is applied.

In an exemplary method of semi-statically changing parameters, a different value of P_{O}_{_{—}}_{PUSCH}(j) of Expression 27 may be set for each subframe group and may be transmitted to the UE. Alternatively, a different value of α(j) of Expression 27 may be set for each subframe group and may be transmitted to the UE. An eNB which instructs uplink power control may previously notify the UE of parameter values which are to be applied to each subframe group or a combination of such values through RRC signaling. Upon receiving the RRC signal, the UE may determine a subframe group to which a subframe in which the UE is to perform uplink transmission belongs and may then determine uplink transmission power using a parameter(s) predetermined for the subframe group.

In the method in which RRC signaling is used for optimal transmission power control for each subframe group as described above, the eNB may previously notify the UE of information regarding a subframe group to which an uplink subframe in which the UE is to perform uplink transmission belongs to allow the UE to determine the subframe group to which the uplink subframe in which the UE is to perform uplink transmission belongs. Information regarding the subframe group may be provided, for example, in the form of a bitmap.

Also, through a specific physical channel in every downlink subframe, the eNB may notify the UE of a subframe group to which an uplink subframe in which the UE is to perform uplink transmission belongs.

Alternatively, the UE may implicitly determine a subframe group to which an uplink subframe in which the UE is to perform uplink transmission belongs based on an associated relation between downlink and uplink subframes. For example, let us assume that a UE receives information indicating a downlink subframe group to which each downlink subframe belongs through a higher layer signal from an eNB. Here, downlink subframe groups are divided into a downlink subframe group in which interference coordination by an interfering cell is applied and a downlink subframe group in which no interference coordination is applied. In this case, when the UE receives an uplink grant in a downlink subframe, the UE may determine an uplink subframe in which uplink transmission is scheduled by the uplink grant. Here, since the UE already knows the downlink subframe group to which the downlink subframe in which the uplink grant has been received belongs, the UE may determine an uplink subframe group to which the uplink subframe in which uplink transmission is scheduled by the uplink grant belongs. That is, when the UE has received an uplink grant in downlink subframes which belong to the same group, the UE may determine that uplink subframes in which uplink transmission is scheduled by the uplink grant belong to the same uplink subframe group. For example, in the case of an FDD system, an uplink grant that is received in a downlink subframe of subframe index n−4 schedules transmission uplink transmission in an uplink subframe of subframe index n (see arrows in FIG. 8 which indicate the associated relations between DL subframes and UL subframes of a macro eNB). Therefore, if downlink subframes n₁−4 and n₂−4 belong to the same downlink subframe group, the UE may determine that uplink subframes n₁ and n₂ belong to the same uplink subframe group. In this manner, the UE may determine an uplink subframe group to which an uplink subframe belongs through reasoning (or implicitly) from information regarding a downlink subframe group without the eNB separately (or explicitly) providing information regarding the uplink subframe group to which the uplink subframe belongs. This can reduce control signaling overhead.

On the other hand, in the method in which parameters are dynamically changed to perform optimal uplink transmission power control for each subframe group, a TPC command applied to each subframe group may be defined and a TPC command corresponding to each subframe group may be transmitted separately (or discriminately) for each subframe group. To accomplish this, a new TPC command which may be individually managed for each subframe group may be additionally defined.

When a discriminated TPC command is applied to each subframe group, an eNB which performs uplink transmission power control may determine a subframe group to which an uplink subframe in which the UE is to perform uplink transmission belongs and may then transmit a TPC command corresponding to the determined subframe group. Accordingly, the UE may apply the TPC command received from the eNB to the uplink subframe.

Here, if the eNB independently manages TPC commands which are applied respectively to subframe groups in the case in which a UE performs uplink power control according to an absolute value mode (i.e., when the accumulation mode is not used to apply the TPC command), UEs (which may include both a UE that operates according to the conventional LTE release-8 or release-9 system, which is hereinafter referred to as a legacy UE, and a UE that operates according to the new LTE-A system (LTE release-10 or subsequent system), which is hereinafter referred to as an LTE-A UE) can perform optimized uplink power control for each subframe group without defining new operations for performing uplink power control for each subframe group.

On the other hand, in the case in which a UE performs uplink power control according to an accumulation mode, a legacy UE may acquire a TPC command through a PDCCH received in a downlink subframe which is a predetermined time (4 subframes in the case of the FDD system) before an uplink subframe in which the UE is to perform uplink transmission and adds the acquired TPC command to a TPC command value f, which has been accumulated until an immediately previous uplink subframe, and may then use the accumulated value of the TPC command to perform transmission power control of the uplink subframe in which uplink transmission is to be performed. Here, when a TPC command is applied independently for each subframe group, it is necessary for the UE to accumulate the TPC command independently for each subframe group. However, the legacy UE cannot perform such an operation since such an operation is not defined in the legacy system (3GPP LTE release-9 or release-9 system). Thus, such an operation may be performed only for the LTE-A UE. The LTE-A UE may operate so as to manage the accumulated value of one or more TPC commands, the number of which corresponds to the number of subframes. For example, in the case of the FDD system, when uplink subframes of subframe indices n₁ and n₂ belong to different subframe groups, the UE may operate such that TPC commands transmitted in downlink subframes of subframe indices n₁−4 and n₂−4 are added to the accumulated values of TPC commands f₁ and f₂ corresponding respectively to the subframe groups.

In the case in which a PDCCH of DCI format 0 is used when an uplink power control operation is performed in such an accumulation mode, the eNB may independently manage TPC commands for respective uplink subframe groups and transmit a TPC command corresponding to a specific subframe group to the UE through a PDCCH and the UE may accumulate TPC commands corresponding to the same uplink subframe group and perform uplink transmission power control.

In addition, in the case in which a PDCCH of DCI format 3/3A masked with a TPC-PUSCH-RNTI of the UE is used when an uplink power control operation is performed in such an accumulation mode, the eNB may independently manage independent TPC commands for respective uplink subframe groups and transmit a TPC command corresponding to a specific subframe group to the UE through a PDCCH. The eNB may also assign discriminated TPC indices to TPC commands applied respectively to subframe groups and transmit the TPC commands through a single PDCCH and may then notify the UE of the TPC index of a TPC command which is to be applied to each subframe group using RRC signaling. The eNB may also assign a plurality of TPC-PUSCH-RNTIs to a single UE and notify the UE of an uplink subframe group for which a TPC command masked with each TPC-PUSCH-RNTI is to be used. When the UE has received a TPC command according to such various methods, the UE may determine a TPC command which is to be applied to the uplink subframe and add the TPC command value to the previous TPC command value to determine uplink transmission power.

The method in which an uplink power control parameter is provided semi-statically using RRC signaling and the method in which an uplink power control parameter is provided dynamically using a TPC command through a PDCCH have been described in the above examples.

In another example, parameters which are to be used in a specific subframe (or a specific subframe group) may be transmitted to the UE through a specific physical channel (for example, a PDCCH) while parameter values that are transmitted to the UE through conventional RRC signaling are basically used from among parameters for uplink power control. A UE which can receive a separate parameter through a specific physical channel may perform uplink transmission power control using a parameter received through the specific physical channel, more preferentially than a parameter received through RRC signaling, in a specific subframe. The specific subframe may be a subframe in which the interfering cell performs interference coordination. That is, uplink power control may be performed without using a separate parameter received through the specific physical channel in a subframe (or a subframe group) in which the interfering cell does not perform interference coordination and uplink power control may be performed preferentially using a separate parameter received through the specific physical channel in a subframe (or a subframe group) in which the interfering cell performs interference coordination.

In another example, parameters which are transmitted to the UE through conventional RRC signaling among uplink power control parameters may be signaled every subframe (i.e., may be signaled dynamically) through a specific physical channel (for example, a PDCCH).

Although the above examples have been described with reference to the case in which uplink power control is performed on a subframe (or subframe group) basis for clarity of explanation as an example, the present invention is not limited to this example and the principle of the present invention may be equally applied to the case in which uplink power control is performed on a time resource unit basis (for example, on an OFDM symbol basis, on a slot basis, or on a subframe basis) and/or on a frequency resource unit basis (for example, on a subcarrier basis, on an RB basis, or on a carrier (CC or cell) basis).

Uplink Power Control in Frequency Domain

The following is a description of a method for controlling uplink transmission power on a frequency resource unit basis (for example, on the basis of one or more subcarriers, on the basis of one or more RBs, and on the basis of one or more carriers (CCs or cells)) in the case in which interference coordination is performed in the frequency domain.

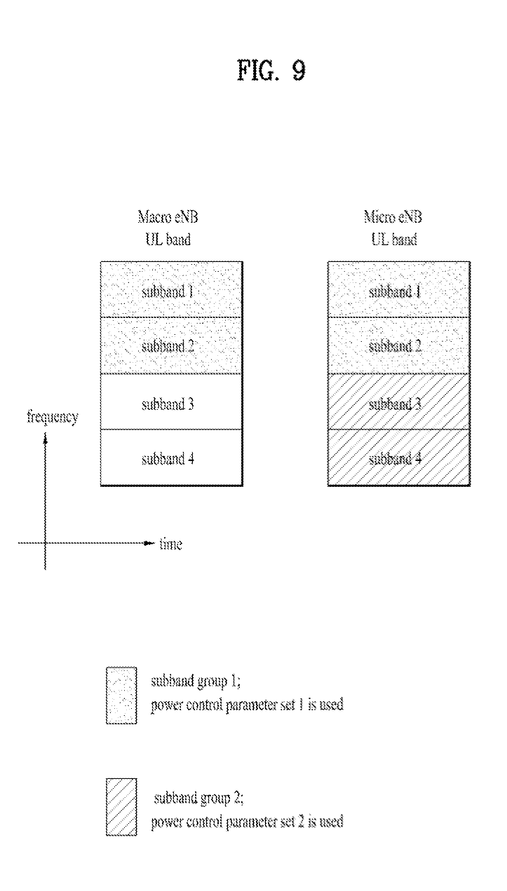

FIG. 9 illustrates an example in which interference coordination is performed in the frequency domain. As shown in FIG. 9, a macro eNB which is an interfering cell may perform interference coordination in a specific subband which includes one or more Resource Blocks (RBs). That is, the interfering cell may set uplink transmission such that uplink transmission is not performed or only a minimal control signal excluding data is transmitted in a specific subband. Here, a micro eNB (for example, a pico eNB or a home eNB) which is a victim cell may perform optimized uplink power control for each of a subband group in which the interfering cell performs interference coordination and a subband group in which the interfering cell does not perform interference coordination.

In a specific example, as shown in FIG. 9, the macro eNB which is the interfering cell may set partial subbands (for example, subbands of subband indices 3 and 4) as coordinated subbands and set transmission such that uplink transmission is not performed or only a minimal control signal excluding data is transmitted in the subbands. As the macro eNB sets signal transmission such that signal transmission is performed in subbands of subband indices 1 and 2 (of subband group 1) and signal transmission is not performed in subbands of subband indices 3 and 4 (of subband group 2) in this manner, a micro eNB which is a victim cell may experience different interference levels (for example, Interference over Thermal (IoT) levels) in subband group 1 and subband group 2. Accordingly, to achieve optimal uplink performance according to an uplink interference level which changes in an uplink subband, the micro eNB may perform optimized uplink power control for each of the subband groups 1 and 2.

Optimized uplink power control for each of the subband groups in the frequency domain may be performed according to the same principle as the method of performing optimized power control for each subframe group in the time domain which has been described above. The method of performing optimized power control in the frequency domain is described below in detail.

For ease of explanation, the PUSCH power control equation described in the above Expression 15 (Expression 27) is rewritten as the following Expression 28.

P_{PUSCH}(i)=min{P_{CMAX},10 log₁₀(M_{PUSCH}(i))+P_{O}_{_{—}}_{PUSCH}(j)+α(j)·PL+Δ_{TF}(i)+f(i)} Expression 28

A detailed description of Expression 28 is omitted herein since it is the same as Expression 15 (or Expression 27). Examples in which uplink transmission power is controlled in the frequency domain when uplink power control is performed using the method of Expression 28 or a similar method are described below.

In an example, the eNB may set different values of P_{O}_{_{—}}_{PUSCH}(j) of Expression 28 for subband groups and transmit the set values to the UE. The eNB may also set different values of α(j) of Expression 28 for subband groups and may transmit the set values to the UE. The eNB may also set different combinations of values of P_{O}_{_{—}}_{PUSCH}(j) and α(j) for subband groups and may transmit the same to the UE. When the eNB sets different values of P_{O}_{_{—}}_{PUSCH}(j) and α(j) for subband groups and transmits the set values in this manner, the eNB may previously notify the UE of the different values set for subband groups through RRC signaling. Upon receiving the RRC signal, the UE may determine a subband group to which a subband in which the UE is to perform uplink transmission belongs and may then determine uplink transmission power using a parameter(s) set for the subband group. Here, to allow the UE to determine a subband group to which a subband in which the UE is to perform uplink transmission belongs, the eNB may provide the UE with information regarding the subband group in the form of a bitmap or the like.

In another example, the eNB may define a TPC command applied to each subframe group and separately (or discriminately) transmit a TPC command corresponding to each subframe group. To accomplish this, a new TPC command which may be individually managed for each subframe group may be additionally defined. In a system to which carrier aggregation is applied, a TPC command may be managed independently for each carrier (CC or cell). The eNB may determine a subband group to which a subband in which the UE is to perform uplink transmission belongs and transmit a TPC command corresponding to the subband group to the UE. Accordingly, the UE may use a received TPC command in a subband corresponding to the TPC command.

Here, in the case in which the UE performs uplink power control according to the accumulation mode using a TPC command received through a PDCCH of DCI format 3/3A, the eNB may transmit TPC commands corresponding respectively to subband groups through a single PDCCH and notify the UE of corresponding TPC indices and may also notify the UE of the TPC index of a TPC command which is to be applied for each subband group through RRC signaling. Alternatively, the eNB may assign a plurality of TPC-PUSCH-RNTIs to a single UE and notify the UE of a subband group for which a TPC command masked with each TPC-PUSCH-RNTI is to be used.

In another example, in the case in which the eNB schedules uplink transmission of a single UE only for subbands belonging to a specific subband group, the UE may control uplink transmission power in the subbands using an uplink power control parameter(s) set for the subband group.

Alternatively, in the case in which the eNB schedules uplink transmission of one UE only for a plurality of subbands belonging to two or more subband groups, the UE may control uplink transmission power in all scheduled subbands using only a parameter(s) set for one of the two or more subband groups. For example, in the case in which the eNB schedules uplink transmission of one UE in subband 2 and subband 3, the UE may apply an uplink power control parameter(s) applied to the subband 2 (or subband 3) to uplink power control of both subbands 2 and 3.

In order to allow the UE to select a subband group for which a parameter to be applied to all scheduled subbands has been set, the eNB may specify the subband group to be selected by the UE through RRC signaling. Alternatively, the eNB may previously specify priority levels of a plurality of subband groups and, when the eNB has scheduled uplink transmission in subbands belonging to two or more of the plurality of subband groups, uplink power control of all subbands may be performed according to a parameter set for one of the two or more subband groups with the highest priority level. Here, in an exemplary method of determining priority levels of subband groups, a subband group having the smallest (lowest) subband index or RB index may be selected preferentially. In another exemplary method of determining priority levels of subband groups, a subband group which has the lowest uplink transmission power when an uplink power control parameter has been applied may be selected preferentially.

Although the above examples have been described with reference to the case in which uplink transmission power control is performed on a time resource unit group basis or a frequency resource unit group basis, the present invention is not limited to this case. That is, a discriminated TPC command may be applied according to a time resource unit group and/or a frequency resource unit group in which uplink transmission power control is performed.

For example, a TPC command which is applied to each group of specific time units (for example, units of one or more OFDM symbols (each unit including one or more OFDM symbols), units of one or more slots (each unit including one or more slots), and/or units of one or more subframes (each unit including one or more subframes)) may be used and a TPC command which is applied to each group of specific time units (for example, units of one or more subcarriers, units of one or more RBs, units of one or more subbands, and/or units of one or more carriers (CCs or cells)) may be used together with or separately from the TPC command which is applied to each group of specific time units.

In an example in which uplink power control is performed on each different group for a combination of the time domain and the frequency domain, when an interfering cell performs frequency domain interference coordination in partial subframes, a victim cell may notify a UE of the subframes in which the interfering cell performs interference coordination and may provide an uplink transmission power parameter(s) and related information items to the UE to allow the UE to perform uplink transmission power control according to each subband group in the subframes.

As an example in which the present invention is extended and applied to units of carriers (CCs or cells), we can consider the case in which a neighbor cell (interfering cell) performs interference coordination for partial subbands (or subband groups) in partial subframes (or subframe groups) in partial carriers (or carrier groups) among a plurality of carriers. In this case, a victim cell may provide the UE with an independent uplink power control parameter(s) and related information for time-frequency resources for which the interfering cell performs interference coordination (i.e., specific subband(s) in specific subframe(s) in carrier(s) for which the interfering cell performs interference coordination), which are discriminated from those of the remaining resources.

The above various examples associated with provision of uplink power control parameters may be performed independently of each other or in combination.

Resource-Specific Power Control

Exemplary situations in which the amount of interference greatly changes between uplink resources are described below before the explanation of various examples of a resource-specific power control method of the present invention.

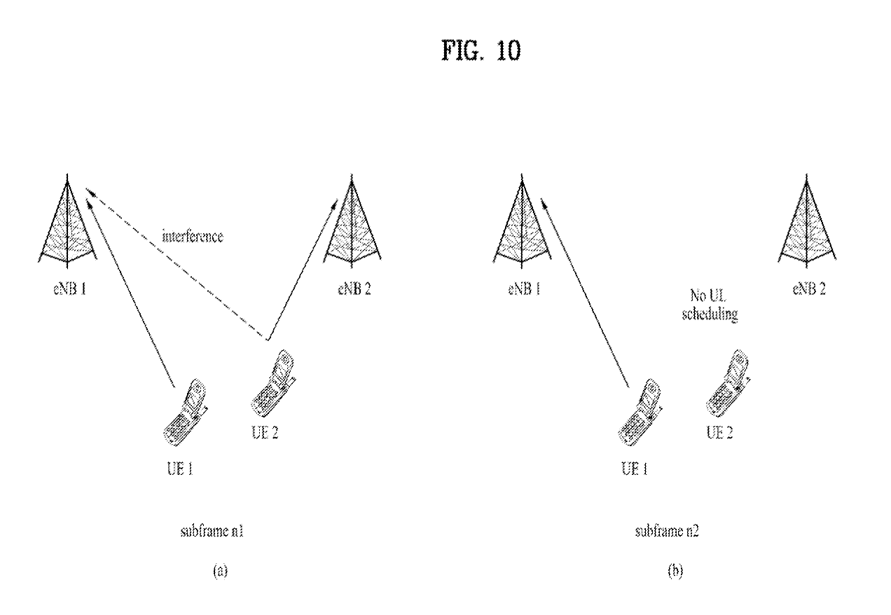

Change in the amount of interference according to the position of a resource (or a resource unit) is described below with reference to FIGS. 10(a) and 10(b). FIGS. 10(a) and 10(b) illustrate an example in which UEs perform uplink transmission at the timings of subframes n1 and n2.

Here, it is assumed that a first UE (UE1) which is served by a first eNB (eNB1) performs uplink transmission in both subframes n1 and n2. It is also assumed that a second UE (UE2) which is served by a second eNB (eNB2) as an adjacent cell does not perform uplink transmission in subframe n2 to reduce intercell interference although the second UE (UE2) performs normal uplink transmission operations in subframe n1. That is, it is assumed that the eNB2 has not scheduled uplink transmission of the UE2 in subframe n2. The case in which the eNB2 has not scheduled uplink transmission of the UE2 in subframe n2 may be considered the case in which, for example, the eNB has not transmitted a PDCCH in a DL subframe in which a UL grant for subframe n2 (i.e., control information for scheduling a PUSCH in subframe n2) may be transmitted. The case in which the eNB has not transmitted a PDCCH in a DL subframe may correspond to the case in which the DL subframe has been set as an Almost Blank Subframe (ABS) or a silent subframe. The ABS or the silent subframe may correspond to a DL subframe in which a PDCCH, a PDSCH, or the like is not transmitted although a minimal control signal (for example, a cell-specific reference signal (CRS)) is transmitted.

When the eNB2 performs such an interference coordination operation, it may be considered that the eNB2 does not perform uplink scheduling of the UE2 in subframe n2 and therefore the eNB1 and UE1 receives interference from the eNB2 and UE2 in subframe n2. On the other hand, since the eNB2 schedules uplink transmission of the UE2 in subframe n1, the eNB1 and UE1 receives interference from the eNB2 and UE2 in subframe n2. Accordingly, the degree of interference experienced by the victim cell may differ according to the position of a resource (for example, the position of a time resource and/or frequency resource) for uplink transmission of the same UE1.

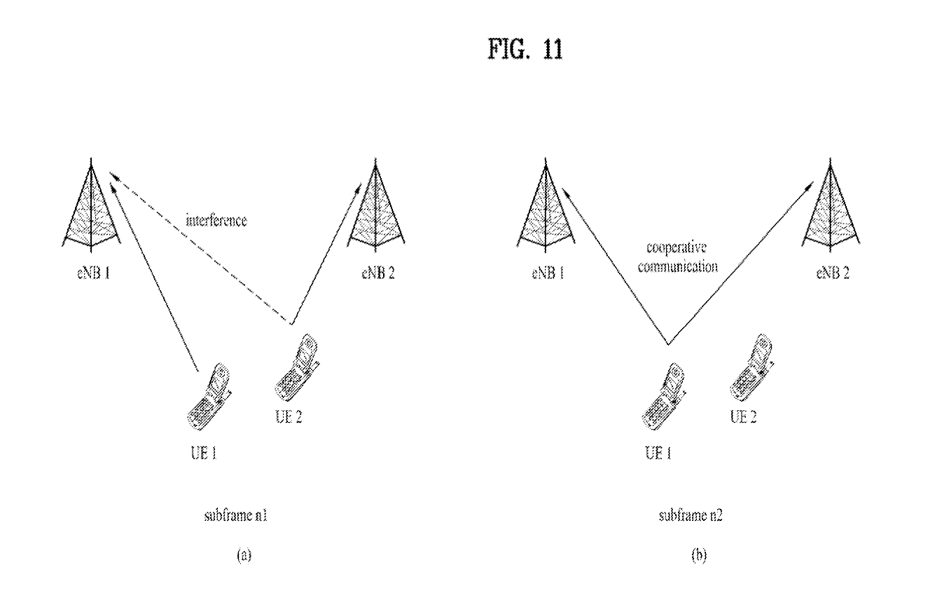

Another example in which the amount of interference changes according to the position of a resource is described below with reference to FIG. 11. In the example of FIG. 11, in subframe n1, a serving cell (eNB1) and an adjacent cell (eNB2) do not perform cooperative communication (see FIG. 11(a)) while, subframe n2, multi-cell cooperative communication is performed between the eNB1 and the eNB2 such that the eNB1 and the eNB2 simultaneously receive an uplink signal transmitted by UE1 and signals received by the two eNBs are combined to reconstruct an original signal (see FIG. 11(b)). In this case, in subframe n1, the eNB1 and the UE1 experience interference caused by uplink transmission of the UE2 while, in subframe n2, the eNB1 and the UE1 do not receive interference from the eNB2 and the UE2. Accordingly, the degree of interference experienced by the victim cell may vary according to the position of a resource (the position of a time resource and/or a frequency resource) for uplink transmission of the same UE1.

As another example in which the amount of interference varies according to the position of a resource, it is possible to consider the case in which a method of using uplink-downlink (UL-DL) resources differs for each cell.

For example, in the case of a TDD system, each cell may have an independent UL-DL configuration (or setting) in order to adapt to UL-DL traffic load which differs in each cell. The term “UL-DL configuration” refers to presetting of an uplink subframe, a downlink subframe, and a special subframe in a radio frame in the TDD system. According to the UL-DL configuration, a subframe may be used for uplink transmission or downlink transmission. For example, subframe index 3 may be set as an uplink subframe according to UL-DL configuration index 0 while subframe index 3 may be set as a downlink subframe according to UL-DL configuration index 2. Even when two adjacent cells use the same UL-DL configuration, one of the cells may perform downlink transmission in an uplink resource. In the FDD system, one of the two adjacent cells may also perform downlink transmission using partial subframes of an uplink band. In the case in which resource utilization of two adjacent cells has not been set equally, the degree of interference experienced by one of the two cells may change according to whether the adjacent cell performs uplink transmission or downlink transmission for an uplink resource.

In the case in which the degree of interference experienced by a victim cell changes according to the position of an uplink resource as in the above various situations, the UE needs to appropriately control uplink transmission power according to the degree of interference of each uplink resource. Here, the uplink resource may be specified by a time resource index (for example, an OFDM symbol index, a slot index, and/or a subframe index) and/or a frequency resource index (for example, a subcarrier index, an RB index, a subband index, and/or a carrier (CC or cell) index). Such appropriate control of uplink transmission power for time-frequency resources which undergo different degrees of interference means that uplink transmission power that the UE applies to a first time-frequency resource may differ from uplink transmission power that the UE applies to a second time-frequency resource. Thus, a command to control transmission power for each time-frequency resource needs to be managed independently. Such an operation for independently controlling uplink transmission power for different time-frequency resources may be referred to as a resource-specific power control operation. Specific examples of the present invention associated with the resource-specific power control operation are described below.

First, an eNB may notify a UE of a discriminated uplink resource set through a higher layer signal such as an RRC signal. The eNB may also provide a power control command applied to a specific uplink resource set. Upon receiving the power control command, the UE may operate to apply the same power control command to uplink resources belonging to the specific uplink resource set and operate so as not to apply the power control command to other uplink resources which do not belong to the specific uplink resource set. For example, when the UE has received a power control command, which instructs the UE to increase transmission power for uplink resource set 1 by 1 dB, from the eNB, the UE may operate so as not to apply the power control command to uplink resource set 2 and operate to maintain the transmission power for uplink resource set 2 at the previous level unless a power control command for uplink resource set 2 is not received from the eNB.

In order to enable such an operation, the eNB may indicate an uplink resource set to which a power control command provided to the UE is to be applied.

For example, the eNB may transmit, to the UE, the index of an uplink resource set, to which a power control command is to be applied, within the power control command (or within a control channel (for example, a PDCCH) in which the power control command is transmitted). This may be referred to as a method of explicitly indicating an uplink resource set to which a power control command is to be applied.

In another example, the eNB may implicitly indicate an uplink resource set to which a power control command is to be applied. That is, the UE may derive the index of an uplink resource set to which each power control command is to be applied from the position of a resource in which the power control command has been transmitted without explicit indication by the eNB.

Specific examples of the present invention associated with a method of implicitly indicating an uplink transmission resource to which a power control command is to be applied are described below.

In an example, a UE may determine an uplink resource to which a power control command is to be applied from a downlink subframe in which the power control command has been transmitted. For example, the UE may determine that a power control command which has been received in a downlink subframe of an odd index is applied to uplink resource set 1 and a power control command which has been received in a downlink subframe of an even index is applied to uplink resource set 2. Through a higher layer signal, the eNB may previously notify the UE of a correspondence relationship (mapping relationship) between the index of a downlink subframe in which a power control command has been transmitted and the index of an uplink resource set to which the power control command is to be applied.

In another example, a power control command received in a specific downlink subframe may be applied to a specific uplink resource set using an associated relation between downlink and uplink subframes. This method is useful especially when an uplink resource set consists of uplink subframes. For example, when the UE has received a power control command in a DL subframe of index n, the UE may determine that the power control command is applied to an uplink resource set including a UL subframe of index n+k. Here, DL subframe n and UL subframe n+k may be set (or configured) according to the following associated relation. For example, DL subframe n and UL subframe n+k may be in a relationship in which a UL grant is received through a PDCCH in DL subframe n and a PUSCH scheduled by the UL grant is transmitted in UL subframe n+k. In this case, transmission power control information which is applied to the PUSCH transmitted in UL subframe n+k may be applied to a UL resource set to which UL subframe n+k belongs. Alternatively, DL subframe n and UL subframe n+k may be in a relationship in which a PDSCH is received in DL subframe n and HARQ ACK/NACK information of the PDSCH is transmitted through a PUCCH in UL subframe n+k. In this case, transmission power control information which is applied to the PUCCH transmitted in UL subframe n+k may be applied to a UL resource set to which UL subframe n+k belongs. Here, k may have a value of, for example, 4.

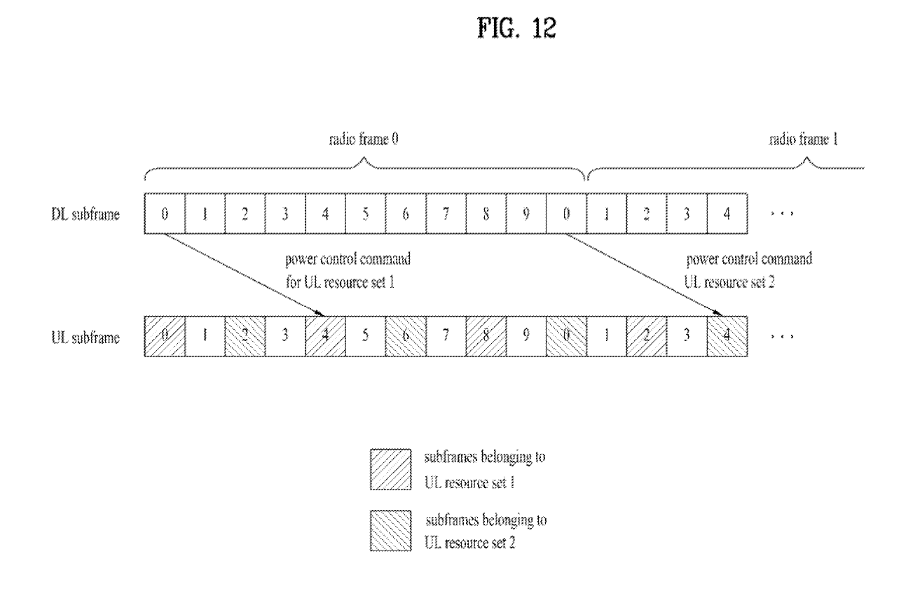

FIG. 12 illustrates an example of resource-specific power control. In the example of FIG. 12, let us assume that a UL grant is received in DL subframe n and a PUSCH scheduled by the UL grant is transmitted in UL subframe n+4 or that a PDSCH is received in DL subframe n and HARQ ACK/NACK information of the PDSCH is transmitted in UL subframe n+4 through a PUCCH. In this case, it is possible to determine a UL subframe in which a PUSCH or a PUCCH, to which a power control command received in a DL subframe is applied, is transmitted. For example, a power control command received in DL subframe 0 of DL radio frame 0 may be applied to a PUSCH (or PUCCH or SRS) which is transmitted in a subframe belonging to UL resource set 1 (UL subframes 0, 4, and 8 of UL radio frame 0 and UL subframes 2, . . . of UL radio frame 1). In addition, a power control command received in DL subframe 0 of DL radio frame 1 may be applied to a PUSCH (or PUCCH or SRS) which is transmitted in a subframe belonging to UL resource set 2 (UL subframes 2 and 6 of UL radio frame 0 and UL subframes 0, 4, . . . of UL radio frame 1).

In addition, a UL subframe set having a specific associated relation with a DL subframe set may be set and a power control command received in one DL subframe included in a DL subframe set may be applied to UL subframes belonging to a UL subframe set corresponding to the DL subframe set. Here, the DL subframe set may be set according to a predetermined rule by an eNB. For example, a DL subframe set may be a group of DL subframes that the eNB has set through a higher layer signal (for example, through RRC signaling) for CSI measurement. For example, in the conventional LTE system, a Received Signal Strength Indicator (RSSI) is defined such that the RSSI is measured for specific OFDM symbols (for example, CRS transmission symbols) of all DL subframes. On the other hand, in the LTE-A system, the RSSI may be defined such that the RSSI is measured in all OFDM symbols of specific DL subframes when it is indicated through higher layer signaling that Reference Signal Received Quality (RSRQ) is to be measured only for the DL subframes in order to reduce the influence of interference. In the LTE-A system, DL CSI measurement may be set to be performed for specific DL subframes (a specific DL subframe set) in this manner and therefore a discriminated DL subframe set may be set. Such a DL subframe set may be associated with a UL subframe set based on a specific associated relation.

The specific associated relation for associating the DL subframe set with the UL subframe set may follow an associated relation between DL subframe n and UL subframe n+k. For example, the specific associated relation may be a relationship in which a UL grant is received in DL subframe n and a PUSCH scheduled by the UL grant is transmitted in UL subframe n+k. Alternatively, the specific associated relation may be a relationship in which a PDSCH is received in DL subframe n and HARQ ACK/NACK information of the PDSCH is transmitted in UL subframe n+k.

When uplink resource-specific power control is performed for a UL subframe set which has a specific associated relation with a DL subframe set, one uplink resource may belong to two or more uplink resource set. In this case, it is possible to perform an operation such that a power control command of the uplink resource is commonly applied to all uplink resource sets to which the uplink resource belongs.

On the other hand, it is preferable that a separate (or different) power control command be applied to each uplink resource set when the degree of interference of each uplink resource differs from each other as described above. However, there may be a need to commonly apply a power control command to all uplink resources (or resource sets) when there is no difference between the degrees of interference of uplink resources or there may be such a need as appropriate even when there is a difference between the degrees of interference of uplink resources.

Various examples of the present invention associated with such common power control command application are described below.

For example, a power control command may be set such that the power control command includes a separate index and it may be explicitly indicated whether the power control command is to be applied to all uplink resources or to a specific uplink resource. Such an index may be set so as to indicate whether or not to perform resource-specific power control. Alternatively, a specific resource to which the power control command is to be applied may be indicated in the form of an index and the index may be set in a format in which a state indicating all resources is additionally defined.

In another example, the resource-specific power control operation described above may be applied only when a power control command is transmitted in a UE-specific search space and the power control command may be applied to all uplink resources regardless of an uplink resource set in other cases (i.e., when the power control command is transmitted in a common search space). Namely, a power control command may be transmitted to a UE through a PDCCH and power control operations may be set such that a resource-specific power control operation is applied or a power control operation is commonly performed for all resources depending on whether a PDCCH in which the power control command is transmitted is detected in a UE-specific search space or in a common search space. The term “search space” refers to a resource element space in which a UE performs PDCCH detection assuming the position (in a resource element) and size of candidate PDCCHs according to each DCI format, “UE-specific search space” refers to a space in which a UE searches for a PDCCH for the UE, and “common search space” refers to a space in which a PDCCH commonly applied to UEs in a cell is searched for.

In another example, an uplink resource set is not necessarily set for all uplink resources and there may be an uplink resource which does not belong to any uplink resource set. In this case, it is possible to perform an operation such that, when a power control command is applied to an uplink resource which does not belong to any uplink resource set, the power control command is applied to all uplink resources. In this case, resource-specific uplink power control may be performed only when the power control command is applied to an uplink resource which belongs to a specific uplink resource set.

In another example, a power control command for a plurality of UEs may be transmitted in the form of a group through a PDCCH as with DCI format 3/3A and, in this case, it is possible to perform an operation such that the power control command is applied to all uplink resources. In this case, resource-specific uplink power control may be performed only when the power control command is applied to only one UE.

Although the above examples of the present invention have been described with reference to the case in which uplink transmission power control is performed on a subframe basis (or a subframe set basis), the present invention is not limited to this case. That is, in the resource-specific power control operation described above, a ‘resource’ may be specified by a time resource, a frequency resource, or a combination of a time resource and a frequency resource. For example, a resource may be specified through a combination of one or more of a specific time unit (for example, a unit of one or more OFDM symbols (a unit including one or more OFDM symbols), a unit of one or more slots (a unit including one or more slots), and/or a unit of one or more subframes (a unit including one or more subframes)) and a specific time unit (for example, a unit of one or more subcarriers, a units of one or more RB, a unit of one or more subband, and/or a unit of one or more carriers (CCs or cells)) and the uplink power control operation may be performed for the specified resource as described above.

The above various examples associated with the resource-specific uplink power control operation may be performed independently of each other or in combination. In addition, the above various examples associated with provision of uplink power control parameters and the above various examples associated with the resource-specific uplink power control operation may be performed independently of each other or in combination.

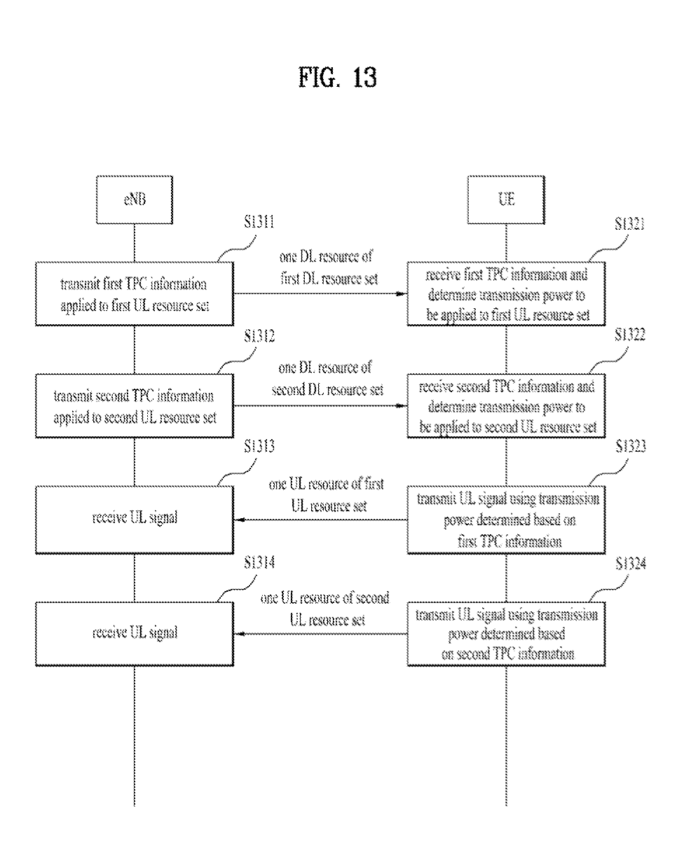

FIG. 13 is a flowchart illustrating an uplink power control method according to an example of the present invention. The uplink power control method described with reference to FIG. 13 is associated with operations of an eNB and a UE according to a method in which a separate Transmit Power Control (TPC) information is applied to each uplink resource (i.e., UE-specifically).

In step S1311, the eNB may transmit first TPC information, which is applied to a first UL resource set, to the UE. The first TPC information may be transmitted to the UE in one DL resource included in the first DL resource set. In step S1321, the UE may receive the first TPC information from the eNB and determine uplink transmission power which is to be applied to the first UL resource set based on the received first TPC information. Similarly, in step S1312, the eNB may transmit second TPC information, which is applied to a second UL resource set, to the UE. The second TPC information may be transmitted to the UE in one DL resource included in the second DL resource set. In step S1322, the UE may receive the second TPC information from the eNB and determine uplink transmission power which is to be applied to the second UL resource set based on the received second TPC information. The UE may determine uplink transmission power according to an absolute value mode or an accumulation mode.

Here, a UL (or DL) resource may be specified by at least one of a time domain resource and a frequency domain resource. For example, a UL (or DL) resource may be specified through a combination of one or more of a specific time unit (for example, a unit of one or more OFDM symbols (a unit including one or more OFDM symbols), a unit of one or more slots (a unit including one or more slots), and/or a unit of one or more subframes (a unit including one or more subframes)) and a specific time unit (for example, a unit of one or more subcarriers, a units of one or more RB, a unit of one or more subband, and/or a unit of one or more carriers (CCs or cells)).

In step 1323, the UE may transmit an uplink signal in one UL resource of the first UL resource set using transmission power determined by the first TPC information. In step S1313, the eNB may receive the uplink signal in the one UL resource of the first UL resource set from the UE. Similarly, in step 1324, the UE may transmit an uplink signal in one UL resource of the second UL resource set using transmission power determined by the second TPC information. In step S1314, the eNB may receive the uplink signal in the one UL resource of the second UL resource set from the UE. Here, the uplink signal may correspond to UL data transmitted through a PUSCH, UL control information transmitted through a PUCCH, or an SRS.

Here, a time-frequency region at which each of the first and second UL resource sets is located or a UL resource to which the first or second UL resource set belongs may be indicated explicitly (for example, in the form of a bitmap) by the eNB.

In addition, it may be explicitly indicated by the eNB that the first (or second) TPC information is applied to the first (or second) UL resource set. It may be determined, based on a correspondence relationship between the first (or second) DL resource set and the first (or second) UL resource set, that the first (or second) TPC information is applied to the first (or second) UL resource set. For example, when TPC information is transmitted in a DL resource, the TPC information transmitted in the DL resource may be applied to a UL resource which is in a specific correspondence relationship (for example, the relationship of UL grant reception and PUSCH transmission or the relationship of PDSCH reception and acknowledgement information transmission) with the DL resource. Setting of the DL resource set may follow setting of a DL subframe group for CSI measurement.

Basically, TPC is applied to each UL resource (i.e., resource-specifically). However, when priority levels for TPC information application have been set for the first and second UL resource set, TPC information for a UL resource set with the higher priority level may be applied to the other UL resource set. Such priority levels may be preset by the eNB or may be determined such that a UL resource set with a lower UL resource index (for example, a lower RB index) has a higher priority level.

The first (or second) TPC information may be provided to the UE through a higher layer signal (for example, RRC signaling) or a physical layer signal (for example, control information through a PDCCH).

Such a method for controlling transmission power in a UL resource-specific manner may be used for accurate and efficient uplink transmission when the level of interference from a neighbor cell differs for each UL resource (i.e., when the level of interference from the neighbor cell in a first UL resource set and the level of interference from the neighbor cell in a second UL resource set are different from each other).

The uplink power control method of the present invention described above with reference to FIG. 13 may be implemented such that each of the various embodiments of the present invention described above is independently applied to the method or 2 or more of the various embodiments of the present invention are simultaneously applied to the method and redundant descriptions are omitted herein for clear explanation of the present invention.

In addition, although the uplink transmission entity is exemplified mainly by a base station (eNB) and the uplink transmission entity is exemplified mainly by a user equipment (UE) in the above description of the various embodiments of the present invention, the scope of the present invention is not limited thereto. That is, the principles of the present invention described above through the various embodiments of the present invention may be equally applied to the case in which a relay serves as an entity for downlink transmission to a user equipment or serves as an entity for uplink reception from a user equipment or the case in which a relay serves as an entity for uplink transmission to a base station or serves as an entity for downlink reception from a base station.

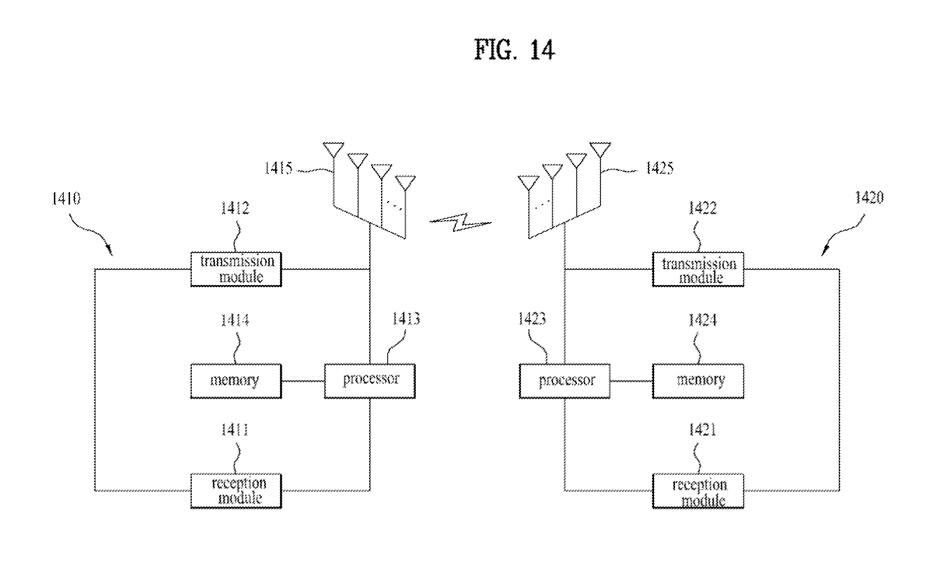

FIG. 14 illustrates configurations of an eNB and a UE according to the present invention.

As shown in FIG. 14, an eNB 1410 according to the present invention may include a reception module 1411, a transmission module 1412, a processor 1413, a memory 1414, and a plurality of antennas 1415. Inclusion of the plurality of antennas 1415 indicates that the eNB 1410 supports MIMO transmission and reception. The reception module 1411 may receive various signals, data, and information in uplink from the UE. The transmission module 1412 may transmit various signals, data, and information in downlink to the UE. The processor 1413 may control overall operation of the eNB 1410.

The eNB 1410 according to an embodiment of the present invention may be configured to transmit transmission power control information in an uplink resource-specific manner. The processor 1413 of the eNB 1410 may be configured to transmit first transmission power control information which is applied to a first uplink resource set to the UE through the transmission module 1412. The processor 1413 may also be configured to transmit second transmission power control information which is applied to a second uplink resource set to the UE through the transmission module 1412. The processor 1413 may also be configured to receive an uplink signal, which is transmitted through one or more uplink resources of the first uplink resource set using uplink transmission power which is based on the first transmission power control information, from the UE through the reception module 1411. The processor 1413 may also be configured to receive an uplink signal, which is transmitted through one or more uplink resources of the second uplink resource set using uplink transmission power which is based on the second transmission power control information, from the UE through the reception module 1411.

The processor 1413 of the eNB 1410 may also function to arithmetically process information such as information received by the eNB 1410 and information to be externally transmitted and the memory 1414 may store the arithmetically processed information or the like for a specific time and may be replaced with a component such as a buffer (not shown).

As shown in FIG. 14, a UE 1420 according to the present invention may include a reception module 1421, a transmission module 1422, a processor 1423, a memory 1424, and a plurality of antennas 1425. The plurality of antennas 1425 indicates that the UE 1420 supports MIMO transmission and reception. The reception module 1421 may receive various signals, data, and information in downlink from the eNB. The transmission module 1422 may transmit various signals, data, and information in uplink to the eNB. The processor 1423 may control overall operation of the UE 1420.

The UE 1420 according to an embodiment of the present invention may be configured to perform uplink transmission according to transmission power control information which is applied in an uplink resource-specific manner. The processor 1423 of the UE 1420 may be configured to receive first transmission power control information which is applied to a first uplink resource set from the eNB through the reception module 1421. The processor 1423 of the UE 1420 may also be configured to receive second transmission power control information which is applied to a second uplink resource set from the eNB through the reception module 1421. The processor 1423 may also be configured to transmit an uplink signal through one or more uplink resources of the first uplink resource set using uplink transmission power which is based on the first transmission power control information to the eNB through the transmission module 1422. The processor 1423 may also be configured to transmit an uplink signal through one or more uplink resources of the second uplink resource set using uplink transmission power which is based on the second transmission power control information to the eNB through the transmission module 1422.

The processor 1423 of the UE 1420 may also function to arithmetically process information such as information received by the UE 1420 and information to be externally transmitted and the memory 1424 may store the arithmetically processed information or the like for a specific time and may be replaced with a component such as a buffer (not shown).

The configurations of the eNB and the UE described above may be implemented such that each of the various embodiments of the present invention described above may be independently applied or 2 or more thereof may be simultaneously applied to the eNB and the UE and redundant descriptions are omitted herein for clear explanation of the present invention.

The description of the eNB 1410 in the above description of FIG. 14 may be equally applied to a relay as a downlink transmission entity or an uplink reception entity and the description of the UE 1420 may be equally applied to a relay as a downlink reception entity or an uplink transmission entity.

The embodiments of the present invention described above may be implemented by various means. For example, the embodiments of the present invention may be implemented by hardware, firmware, software, or any combination thereof.

In the case in which the present invention is implemented by hardware, the methods according to the embodiments of the present invention may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, or the like.

In the case in which the present invention is implemented by firmware or software, the methods according to the embodiments of the present invention may be implemented in the form of modules, processes, functions, or the like which perform the features or operations described below. Software code can be stored in a memory unit so as to be executed by a processor. The memory unit may be located inside or outside the processor and can communicate data with the processor through a variety of known means.

The detailed description of the exemplary embodiments of the present invention has been given to enable those skilled in the art to implement and practice the invention. Although the invention has been described with reference to the exemplary embodiments, those skilled in the art will appreciate that various modifications and variations can be made in the present invention without departing from the spirit or scope of the invention described in the appended claims. For example, those skilled in the art may combine the structures described in the above embodiments in a variety of ways. Accordingly, the invention should not be limited to the specific embodiments described herein, but should be accorded the broadest scope consistent with the principles and novel features disclosed herein.

Those skilled in the art will appreciate that the present invention may be embodied in other specific forms than those set forth herein without departing from the spirit and essential characteristics of the present invention. The above description is therefore to be construed in all aspects as illustrative and not restrictive. The scope of the invention should be determined by reasonable interpretation of the appended claims and all changes coming within the equivalency range of the invention are intended to be embraced within the scope of the invention. In addition, it will be apparent that claims which are not explicitly dependent on each other can be combined to provide an embodiment or new claims can be added through amendment after this application is filed.

### INDUSTRIAL APPLICABILITY

The embodiments of the present invention are applicable to various mobile communication systems.

1. A method for transmitting uplink transmission power control information by a base station in a wireless communication system, the method comprising:
transmitting first transmission power control information, which is applied to a first uplink resource set, to a user equipment;
transmitting second transmission power control information, which is applied to a second uplink resource set, to the user equipment;
receiving an uplink signal, which is transmitted through one or more uplink resources of the first uplink resource set using uplink transmission power which is based on the first transmission power control information, from the user equipment; and
receiving an uplink signal, which is transmitted through one or more uplink resources of the second uplink resource set using uplink transmission power which is based on the second transmission power control information, from the user equipment.

2. The method according to claim 1, wherein the first and second uplink resource sets which are applied respectively to the first and second transmission power control information are indicated explicitly by the base station or are determined based on a correspondence relationship between one downlink resource of the first downlink resource set in which the first transmission power control information is transmitted and one uplink resource of the first uplink resource set and a correspondence relationship between one downlink resource of the second downlink resource set in which the second transmission power control information is transmitted and one uplink resource of the second uplink resource set.

3. The method according to claim 2, wherein the correspondence relationship is a relationship in which uplink grant information transmitted in a downlink resource belonging to the first and second resource sets respectively schedules uplink data transmission in an uplink resource belonging to the first and second uplink resource sets or a relationship in which acknowledgement information of downlink data transmitted in a downlink resource belonging to the first and second resource sets is transmitted respectively in an uplink resource belonging to the first and second uplink resource sets.

4. The method according to claim 1, wherein priority levels for application of transmission power control information for the first and second uplink resource sets are set and transmission power control information for an uplink resource set with a higher priority level is also applied to the other uplink resource set.

5. The method according to claim 1, wherein the first and second transmission power control information includes transmission power control information regarding a Physical Uplink Shared Channel (PUSCH), a Physical Uplink Control Channel (PUCCH), or a Sounding Reference Signal (SRS).

6. The method according to claim 1, wherein a level of interference from a neighbor cell in the first uplink resource set is different from a level of interference from the neighbor cell in the second uplink resource set.

7. A method for performing uplink transmission by a user equipment in a wireless communication system, the method comprising:
receiving first transmission power control information, which is applied to a first uplink resource set, from a base station;
receiving second transmission power control information, which is applied to a second uplink resource set, from the base station;
transmitting an uplink signal through one or more uplink resources of the first uplink resource set using uplink transmission power which is based on the first transmission power control information to the base station; and
transmitting an uplink signal through one or more uplink resources of the second uplink resource set using uplink transmission power which is based on the second transmission power control information to the base station.

8. The method according to claim 7, wherein the first and second uplink resource sets which are applied respectively to the first and second transmission power control information are indicated explicitly by the base station or are determined based on a correspondence relationship between one downlink resource of the first downlink resource set in which the first transmission power control information is transmitted and one uplink resource of the first uplink resource set and a correspondence relationship between one downlink resource of the second downlink resource set in which the second transmission power control information is transmitted and one uplink resource of the second uplink resource set.

9. The method according to claim 8, wherein the correspondence relationship is a relationship in which uplink grant information transmitted in a downlink resource belonging to the first and second resource sets respectively schedules uplink data transmission in an uplink resource belonging to the first and second uplink resource sets or a relationship in which acknowledgement information of downlink data transmitted in a downlink resource belonging to the first and second resource sets is transmitted respectively in an uplink resource belonging to the first and second uplink resource sets.

10. The method according to claim 7, wherein priority levels for application of transmission power control information for the first and second uplink resource sets are set and transmission power control information for an uplink resource set with a higher priority level is also applied to the other uplink resource set.

11. The method according to claim 7, wherein the first and second transmission power control information includes transmission power control information regarding a Physical Uplink Shared Channel (PUSCH), a Physical Uplink Control Channel (PUCCH), or a Sounding Reference Signal (SRS).

12. The method according to claim 7, wherein a level of interference from a neighbor cell in the first uplink resource set is different from a level of interference from the neighbor cell in the second uplink resource set.

13. A base station for transmitting uplink transmission power control information in a wireless communication system, the base station comprising:
a reception module for receiving an uplink signal from a user equipment;
a transmission module for transmitting a downlink signal to the user equipment; and
a processor for controlling the base station including the reception module and the transmission module,
wherein the processor is configured to transmit first transmission power control information, which is applied to a first uplink resource set, to the user equipment through the transmission module, to transmit second transmission power control information, which is applied to a second uplink resource set, to the user equipment through the transmission module, to receive an uplink signal, which is transmitted through one or more uplink resources of the first uplink resource set using uplink transmission power which is based on the first transmission power control information, from the user equipment through the reception module, and to receive an uplink signal, which is transmitted through one or more uplink resources of the second uplink resource set using uplink transmission power which is based on the second transmission power control information, from the user equipment through the reception module.

14. A user equipment for performing uplink transmission in a wireless communication system, the user equipment comprising:
a reception module for receiving a downlink signal from a base station;
a transmission module for transmitting an uplink signal to the base station; and
a processor for controlling the user equipment including the reception module and the transmission module,
wherein the processor is configured to receive first transmission power control information, which is applied to a first uplink resource set, from the base station through the reception module, to receive second transmission power control information, which is applied to a second uplink resource set, from the base station through the reception module, to transmit an uplink signal through one or more uplink resources of the first uplink resource set using uplink transmission power which is based on the first transmission power control information to the base station through the transmission module, and to transmit an uplink signal through one or more uplink resources of the second uplink resource set using uplink transmission power which is based on the second transmission power control information to the base station through the transmission module.
